(19) United States
(12) Patent Application Publication
(10) Pub. No.: US 2025/0312691 A1
(43) Pub. Date: Oct. 9, 2025

(54) GAME SYSTEM AND GAME PROCESSING METHOD

(71) Applicant: NINTENDO CO., LTD., Kyoto (JP)

(72) Inventor: Takafumi MASAOKA, Kyoto (JP)

(21) Appl. No.: 19/092,485

(22) Filed: Mar. 27, 2025

(30) Foreign Application Priority Data
Apr. 8, 2024 (JP) 2024-061969

(51) Int. Cl. A63F 13/25; A63F 13/327; A63F 13/5252; A63F 13/98

(52) U.S. Cl. CPC A63F 13/25; A63F 13/327; A63F 13/5252; A63F 13/98

(57) ABSTRACT

A parent apparatus communicates with at least one child apparatus, obtains first operation data based on an input to an operation device included in or connected to the parent apparatus, executing a game process based on at least the first operation data, generates a first image and at least one second image based on the game process, outputs the first image to a display device included in or connected to the parent apparatus, and transmits the at least one second image to the at least one child apparatus, respectively. Each child apparatus communicates with the parent apparatus, and outputs the second image received from the parent apparatus to a display device included in or connected to the child apparatus.

### CROSS REFERENCE TO RELATED APPLICATION

This application claims priority to Japanese Patent Application No. 2024-061969, filed on Apr. 8, 2024, the entire contents of which are incorporated herein by reference.

### FIELD

The technology disclosed herein relates to game systems and game processing methods in which a game is executed using a plurality of information processing apparatuses.

### BACKGROUND AND SUMMARY

There has conventionally been a technique of executing a game between a plurality of information processing apparatuses, one of which serves as a parent apparatus and the others of which serve as a child apparatus, by distributing images from the parent apparatus to the child apparatuses.

However, there has been room for improvement in executing a game by a wider variety of methods using an information processing system having a function of distributing an image from a parent apparatus to child apparatuses.

With the above in mind, the present example discloses a game system and game processing method having a function of distributing an image from a parent apparatus to child apparatuses, and capable of executing a game by novel and various methods.

The present example may have the following features (1) to (10), for example.

(1)

An example configuration of a game system according to the present example comprises: a plurality of information processing apparatuses including one or more processors; and an attachment configured to fix at least one of the plurality of information processing apparatuses in an arrangement. At least one of the plurality of information processing apparatuses serves as a parent apparatus, and the other information processing apparatuses serve as a child apparatus. The one or more processors of the parent apparatus are configured to execute information processing including communicating with at least one of the child apparatuses, obtaining first operation data based on an input to an operation device included in or connected to the parent apparatus, executing a game process based on at least the first operation data, generating a first image and at least one second image based on the game process, outputting the first image to a display device included in or connected to the parent apparatus, and transmitting the at least one second image to the at least one child apparatus, respectively. The one or more processors of each child apparatus are configured to execute information processing including communicating with the parent apparatus, and outputting the second image received from the parent apparatus to a display device included in or connected to the child apparatus.

With the configuration of (1), the at least one information processing apparatus in the game system having a function of transmitting an image from the parent apparatus to the child apparatus is fixed in an arrangement by the attachment, whereby a game can be played by novel and various methods.

(2)

In the configuration of (1), the arrangement may be such that the display devices included in the plurality of information processing apparatuses are arranged in a horizontal direction. In this case, the attachment may be configured to fix adjacent ones in the horizontal direction of the plurality of information processing apparatuses to each other.

With the configuration of (2), the plurality of information processing apparatuses are fixed to each other by the attachment in an arrangement in which the plurality of information processing apparatuses are arranged adjacent to each other in the horizontal direction, whereby a game can be played by novel and various methods.

(3)

In the configuration of (2), each information processing apparatus may include a groove configured to integrally fix the operation device thereto. In this case, the attachment may be configured to be fixed to the grooves of two adjacent ones of the plurality of information processing apparatuses instead of the operation device being fixed to the two grooves.

With the configuration of (3), the attachment can be fixed by utilizing the groove that is used when an operation device is attached to the information processing apparatus.

(4)

In any one of the configurations (1) to (3), the one or more processors of the parent apparatus may be configured to execute information processing including generating, as the first image and the second images, images based on virtual cameras arranged at positions based on an arrangement of the plurality of information processing apparatuses in a virtual space, and executing the game process on a range included in each second image in the virtual space, the range being a respective period of time later than a range included in the first image.

With the configuration of (4), an influence of a communication delay from the parent apparatus to the child apparatus can be reduced.

(5)

In the configuration of (1) or (4), the arrangement may be such that the display devices included in the plurality of information processing apparatuses are arranged in a vertical direction. In this case, the attachment may be configured to fix adjacent ones in the vertical direction of the plurality of information processing apparatuses to each other.

With the configuration of (5), the plurality of information processing apparatuses are fixed to each other by the attachment in an arrangement in which the plurality of information processing apparatuses are arranged adjacent to each other in the vertical direction, whereby a game can be played by novel and various methods.

(6)

In the configuration of (5), the arrangement may be such that the display devices included in two of the information processing apparatuses are arranged in the vertical direction. In this case, the attachment may include a first and a second support member each configured to support the respective one of the two information processing apparatuses, and a hinge member configured to connect the first and second support members together and bend at the connection portion.

With the configuration of (6), the information processing apparatuses arranged adjacent to each other in the vertical direction can be folded to meet each other, which allows the apparatuses to be carried, stored, and the like in a smaller form.

(7)

In the configuration of (1) or (4), the arrangement may be such that the display device included in the child apparatus is fixed to the display device connected to the parent apparatus. In this case, the attachment may be configured to fix the display device included in the child apparatus to the display device connected to the parent apparatus.

With the configuration of (7), a game can be played by utilizing the display device included in the child apparatus as a sub-screen of the display device connected to the parent apparatus.

(8)

In the configuration of (7), the first image may be based on a first virtual camera in a virtual space. The second image may be based on a second virtual camera configured to capture an enlarged image of a position included in a range of view of the first virtual camera.

With the configuration of (8), a game can be played, mainly viewing the virtual space displayed on the display device connected to the parent apparatus while checking a state of a remote region in the virtual space displayed on the display device included in the child apparatus.

(9)

In the configuration of (7), the first image may be based on a first virtual camera in a virtual space. The second image may be based on a second virtual camera facing in a direction opposite to a direction in which the first virtual camera faces.

With the configuration of (9), a game can be played, mainly viewing a front region in the virtual space displayed on the display device connected to the parent apparatus while checking a state of a rear region in the virtual space displayed on the display device included in the child apparatus.

(10)

In any one of the configurations (1) to (9), the one or more processors of the child apparatus may be further configured to transmit, to the parent apparatus, second operation data based on an input to an operation device included in or connected to the child apparatus. In this case, the one or more processors of the parent apparatus may be further configured to execute a game process based on the second operation data.

With the configuration of (10), a game process can be executed, additionally based on an input to an operation device included in or connected to the child apparatus.

The present example may also be carried out in the form of a game processing method.

According to the present example, at least one information processing apparatus is fixed in a predetermined arrangement by an attachment, and therefore, a game can be executed by novel and various methods.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example of a state in which a left controller 3 and a right controller 4 are attached to a main body apparatus 2,

FIG. 2 is a diagram showing a non-limiting example of a state in which a left controller 3 and a right controller 4 are detached from a main body apparatus 2,

FIG. 3 is a block diagram showing a non-limiting example of internal configurations of a main body apparatus 2, a left controller 3, and a right controller 4,

FIG. 4 is a diagram showing a non-limiting example of an overview of a game system 10 configured by a plurality of information processing apparatuses 1 performing local communication with each other,

FIG. 5 is a diagram showing a non-limiting example of an overview of a game system 10 configured by a plurality of information processing apparatuses 1 performing the Internet communication with each other,

FIG. 6 is a diagram showing a non-limiting example of a state in which main body apparatuses 2a and 2b are fixed to each other by an attachment 8a,

FIG. 7 is a diagram showing a non-limiting example of a game image displayed in a first system configuration,

FIG. 8 is a diagram showing a non-limiting example of a game space used in a first system configuration,

FIG. 9 is a diagram showing a non-limiting example of a state in which main body apparatuses 2a to 2c are fixed to each other by attachments 8a and 8b,

FIG. 10 is a diagram showing a non-limiting example of a state in which main body apparatuses 2a and 2b are fixed to each other by an attachment 8c,

FIG. 11 is a diagram showing a non-limiting example of a state in which a main body apparatus 2b is fixed to a stationary monitor 5 by an attachment 8d,

FIG. 12 is a diagram showing a non-limiting example of a game image displayed in a third system configuration,

FIG. 13 is a diagram showing another non-limiting example of a game image displayed in a third system configuration,

FIG. 14 is a diagram showing another non-limiting example of a game space used in a third system configuration,

FIG. 15 is a diagram showing another non-limiting example of a data area set in a parent apparatus,

FIG. 16 is a diagram showing another non-limiting example of a data area set in a child apparatus,

FIG. 17 is a flow chart showing a non-limiting example of a parent apparatus process executed in a parent apparatus, and

FIG. 18 is a flow chart showing a non-limiting example of a child apparatus process executed in a child apparatus.

### DETAILED DESCRIPTION OF NON-LIMITING EXAMPLE EMBODIMENTS

### Description of Information Processing Apparatus

An information processing apparatus used in the present example is described below. An example of an information processing apparatus 1 includes a main body apparatus 2, a left controller 3, and a right controller 4. Each of the left controller 3 and the right controller 4 is configured to be attachable to and detachable from the main body apparatus 2. That is, the information processing apparatus 1 can be used as a unified apparatus obtained by attaching the left controller 3 and the right controller 4 to the main body apparatus 2. Further, the information processing apparatus 1 can also be used by detaching the left controller 3 and the right controller 4 from the main body apparatus 2. Hereinafter, the configuration of the information processing apparatus 1 according to the present example is described, and then, a game system including a plurality of information processing apparatuses 1 is described.

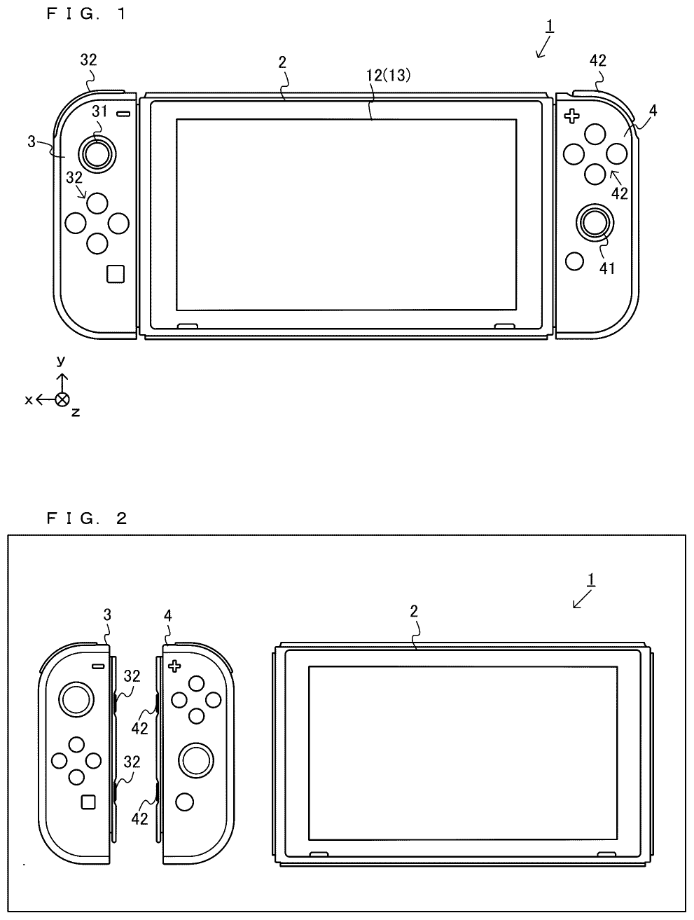

FIG. 1 is a diagram showing an example of the information processing apparatus 1 in the state where the left controller 3 and the right controller 4 are attached to the main body apparatus 2. FIG. 2 is a diagram showing an example of the information processing apparatus 1 in the state where the left controller 3 and the right controller 4 are detached from the main body apparatus 2. As shown in FIG. 1, each of the left controller 3 and the right controller 4 is attached to and unified with the main body apparatus 2. The main body apparatus 2 is an apparatus for performing various processes (e.g., game processing) in the information processing apparatus 1.

The main body apparatus 2 includes a display 12. The display 12 displays an image generated by the main body apparatus 2. The display 12 may be a display device of any type. For example, the display 12 may be a liquid crystal display device (LCD), or may be an organic EL display device.

Further, the main body apparatus 2 includes a touch panel 13 on a screen of the display 12. In the present example, the touch panel 13 is of a type that allows a multi-touch input (e.g., a capacitive type). The touch panel 13, however, may be of any type. For example, the touch panel 13 may be of a type that allows a single-touch input (e.g., a resistive type).

Each of the left controller 3 and the right controller 4 has a vertically long shape (i.e., a long shape in a y-axis direction shown in FIG. 1). In the state where each of the left controller 3 and the right controller 4 is detached from the main body apparatus 2, the controller can be held in the orientation in which the controller is vertically long, and can also be held in the orientation in which the controller is horizontally long.

The left controller 3 includes an analog stick 31 for a user to provide a direction input, and a plurality of operation buttons 32 for the user to perform a pressing operation. The right controller 4 includes an analog stick 41 for the user to provide a direction input, and a plurality of operation buttons 42 for the user to perform a pressing operation. Each of the left controller 3 and the right controller 4 may include an acceleration sensor and an angular velocity sensor within and be able to detect the motion and the orientation of the controller. Hereinafter, the left controller 3 and the right controller 4 are occasionally collectively referred to as a “first controller”.

The main body apparatus 2 to which the left controller 3 and the right controller 4 are attached (the information processing apparatus 1) is of a size that can be carried by the user. For example, the user performs a game operation using the left controller 3 and the right controller 4 by holding the left controller 3 unified with the main body apparatus 2 with their left hand and holding the right controller 4 unified with the main body apparatus 2 with their right hand and plays a game while viewing a game image displayed on the display 12 in front of the user. Hereinafter, a play form in which as described above, in the state where the left controller 3 and the right controller 4 are attached to the main body apparatus 2, the user performs a game operation using the left controller 3 and the right controller 4 and plays a game while viewing a game image displayed on the display 12 is occasionally referred to as a “mobile mode”.

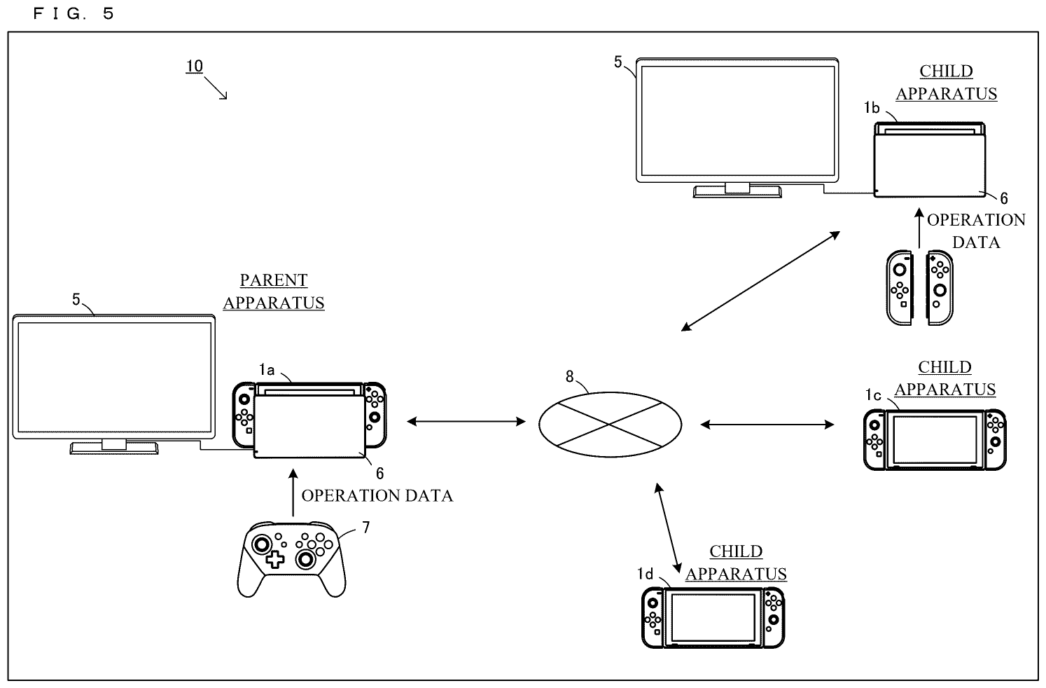

As shown in FIG. 2, the left controller 3 and the right controller 4 can be detached from the main body apparatus 2. In the state where the left controller 3 and the right controller 4 are detached from the main body apparatus 2, the left controller 3 and the right controller 4 are wirelessly connected to the main body apparatus 2. For example, a stand for standing the main body apparatus 2 is provided on a back surface of the main body apparatus 2. Using the stand, the user can place the main body apparatus 2 in the state where the main body apparatus 2 stands on a table so that the screen of the display 12 is almost perpendicular to the table. Alternatively, the user may place the main body apparatus 2 on the table so that the screen of the display 12 of the main body apparatus 2 faces up. The user can detach the left controller 3 and the right controller 4 from the main body apparatus 2, perform a game operation using the left controller 3 and/or the right controller 4, and play a game while viewing a game image displayed on the display 12 of the main body apparatus 2 placed on the table. Hereinafter, a play form in which as described above, the left controller 3 and the right controller 4 are wirelessly connected to the main body apparatus 2, and the user performs a game operation using the left controller 3 and/or the right controller 4 and plays a game while viewing a game image displayed on the display 12 is occasionally referred to as a “table mode”. To the main body apparatus 2, a second controller 7 (see FIG. 5) different from the left controller 3 and the right controller 4 may be able to be wirelessly connected. The second controller may be a controller that can be operated by the user by holding the controller with both hands. A play form in which as described above, the second controller is wirelessly connected to the main body apparatus 2, and the user performs a game operation using the second controller and plays a game while viewing a game image displayed on the display 12 is also referred to as a “table mode”. Hereinafter, the first controller and the second controller are occasionally collectively referred to as a “controller”.

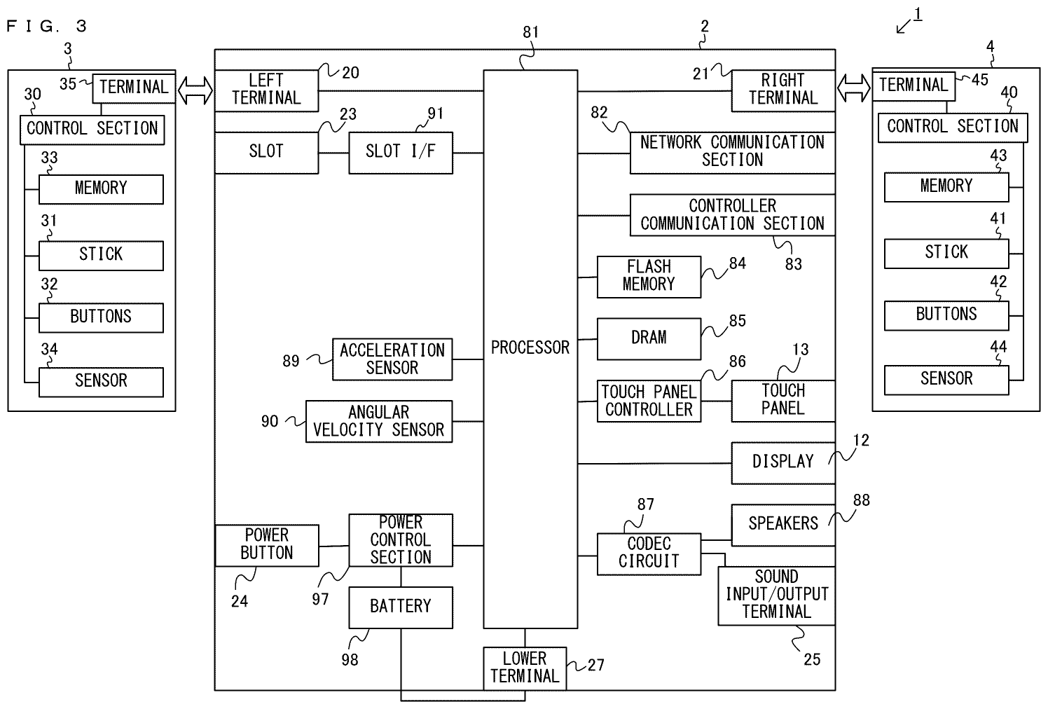

The user can also connect the main body apparatus 2 to a stationary monitor (e.g., television) 5 via a cradle 6 and play a game while viewing a game image displayed on the stationary monitor 5 (see FIG. 5). In the main body apparatus 2, a lower terminal 27 (see FIG. 3) for connecting to the cradle 6 is provided. The main body apparatus 2 is connected to the stationary monitor 5 in a wired manner via the cradle 6. A play form in which as described above, the user plays a game while viewing an image displayed on the external stationary monitor 5 different from the display 12 is occasionally referred to as a “stationary mode”. In a case where the information processing apparatus 1 operates in the stationary mode, the first controller (the left controller 3 and the right controller 4) may be detached from the main body apparatus 2 and wirelessly connected to the main body apparatus 2, and the user may perform a game operation using the first controller. Alternatively, in a case where the information processing apparatus 1 operates in the stationary mode, in the state where the left controller 3 and the right controller 4 are attached to the main body apparatus 2, another first controller or the second controller may be wirelessly connected to the main body apparatus 2, and the user may perform a game operation using the first controller or the second controller.

Next, the internal configuration of the information processing apparatus 1 is described. FIG. 3 is a block diagram showing an example of the internal configuration of the information processing apparatus 1.

As shown in FIG. 3, the main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) including one or more CPUs and one or more GPUs (Graphics Processing Units). The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the present example, the network communication section 82 can directly wirelessly communicate with another main body apparatus 2 present in the communication range of this main body apparatus 2 using a predetermined communication method (e.g., a communication method based on a unique protocol or a method compliant with the Wi-Fi standard). Via a wireless LAN access point present in the communication range of this main body apparatus 2, the network communication section 82 may also be able to communicate with another main body apparatus 2 connected to a local area network including the access point using a method compliant with the Wi-Fi standard. Here, such direct communication with another main body apparatus 2 and such communication in a local area network via a wireless LAN access point are referred to as “local communication”. The network communication section 82 can connect to the Internet by connecting to a wireless LAN using a method compliant with the Wi-Fi standard, and can communicate with another apparatus connected to the Internet. The main body apparatus 2 may be able to connect to a wired LAN, and may be able to connect to the Internet via the wired LAN. For example, the main body apparatus 2 may be able to connect to the wired LAN via the cradle 6. Here, such communication with another apparatus via the Internet is referred to as “Internet communication”.

The main body apparatus 2 includes a controller communication section 83. The controller communication section 83 is connected to the processor 81. The controller communication section 83 wirelessly communicates with the left controller 3 and/or the right controller 4. The controller communication section 83 can also wirelessly communicate with the second controller. The communication method between the main body apparatus 2 and the left controller 3 and the right controller 4 (or the second controller) is optional. In the present example, the controller communication section 83 performs communication compliant with the Bluetooth (registered trademark) standard with the left controller 3 and with the right controller 4.

The processor 81 is connected to a left terminal 20, a right terminal 21, and a lower terminal 27. When performing wired communication with the left controller 3, the processor 81 transmits data to the left controller 3 via the left terminal 20 and also receives operation data from the left controller 3 via the left terminal 20. Further, when performing wired communication with the right controller 4, the processor 81 transmits data to the right controller 4 via the right terminal 21 and also receives operation data from the right controller 4 via the right terminal 21. Further, when communicating with the cradle 6, the processor 81 transmits data to the cradle 6 via the lower terminal 27. As described above, in the present example, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle 6, the main body apparatus 2 can output data (e.g., image data or sound data) to the stationary monitor 5 or the like via the cradle 6.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

Further, the main body apparatus 2 includes an acceleration sensor 89. In the present example, the acceleration sensor 89 detects the magnitudes of accelerations along predetermined three axial (e.g., xyz axes shown in FIG. 1) directions. It should be noted that the acceleration sensor 89 may detect an acceleration along one axial direction or accelerations along two axial directions.

Further, the main body apparatus 2 includes an angular velocity sensor 90. In the present example, the angular velocity sensor 90 detects angular velocities about predetermined three axes (e.g., the xyz axes shown in FIG. 1). It should be noted that the angular velocity sensor 90 may detect an angular velocity about one axis or angular velocities about two axes.

The acceleration sensor 89 and the angular velocity sensor 90 are connected to the processor 81, and the detection results of the acceleration sensor 89 and the angular velocity sensor 90 are output to the processor 81. Based on the detection results of the acceleration sensor 89 and the angular velocity sensor 90, the processor 81 can calculate information regarding the motion and/or the orientation of the main body apparatus 2.

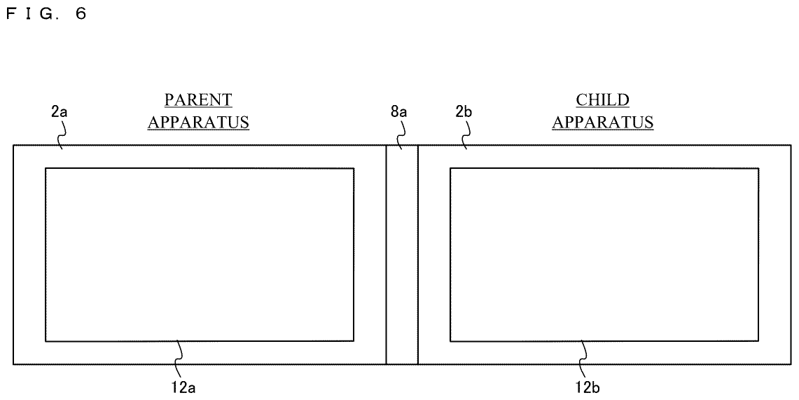

The main body apparatus 2 includes a power button 24, a power control section 97, and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 20, and the right terminal 21). Based on a command from the processor 81, the power control section 97 controls the supply of power from the battery 98 to the above components.

Further, the battery 98 is connected to the lower terminal 27. When an external charging device (e.g., the cradle 6) is connected to the lower terminal 27, and power is supplied to the main body apparatus 2 via the lower terminal 27, the battery 98 is charged with the supplied power.

The left controller 3 includes a terminal 35 that is connected to the left terminal 20 of the main body apparatus 2. The left controller 3 also includes a control section 30. The control section 30 is connected to components including the terminal 35. The control section 30 controls the method for communication performed by the left controller 3 with the main body apparatus 2. In the present example, the control section 30 can communicate with the main body apparatus 2 through both wired communication via the terminal 35 and wireless communication via an antenna (not shown). That is, when the left controller 3 is attached to the main body apparatus 2, the control section 30 communicates with the main body apparatus 2 via the terminal 35. Further, when the left controller 3 is detached from the main body apparatus 2, the control section 30 wirelessly communicates with the main body apparatus 2 (specifically, the controller communication section 83). The wireless communication between the controller communication section 83 and the control section 30 is performed in accordance with the Bluetooth (registered trademark) standard, for example.

Further, the left controller 3 includes a memory 33 such as a flash memory. The control section 30 includes, for example, a microcomputer (or a microprocessor) and executes firmware stored in the memory 33, thereby performing various processes.

The left controller 3 includes the analog stick (“stick” in FIG. 3) 31 and the plurality of operation buttons 32. Information regarding an operation performed on each of the analog stick 31 and the plurality of operation buttons 32 is output to the control section 30 repeatedly at appropriate timing.

Further, the left controller 3 includes a sensor 34. The sensor 34 includes an acceleration sensor and an angular velocity sensor. The acceleration sensor detects the magnitudes of accelerations along the xyz axis directions shown in FIG. 1, and the angular velocity sensor detects angular velocities about the xyz axes. The detection results of the acceleration sensor and the angular velocity sensor are output to the control section 30 repeatedly at appropriate timing.

The control section 30 acquires information regarding an input (specifically, information regarding an operation on each of the analog stick 31 and the operation buttons 32 or the detection result of the sensor 34) from each of the operation buttons 32, the analog stick 31, and the sensor 34. The control section 30 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can determine operations on the analog stick 31 and the operation buttons 32 based on the operation data. Further, based on the detection result of the sensor 34, the main body apparatus 2 can acquire information regarding the motion and/or the orientation of the left controller 3.

Although not shown in the figures, the left controller 3 includes a battery that supplies power to the above components. The left controller 3 may also include a vibrator.

As shown in FIG. 3, the right controller 4 includes a terminal 45 that is connected to the right terminal 21 of the main body apparatus 2, a control section 40, a memory 43, a stick 41, a plurality of operation buttons 42, and a sensor 44. These components have functions similar to those of the above components of the left controller 3, and therefore are not described.

### Description of Game System Including Plurality of Information Processing Apparatuses

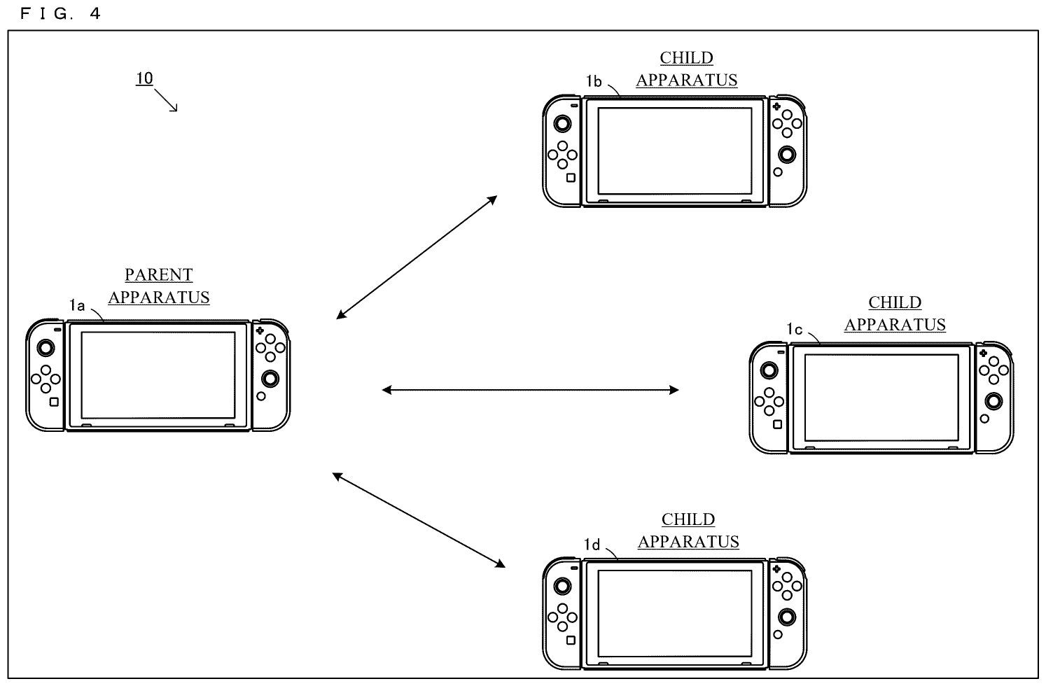

A description is given below of an example of a game system 10 for performing a game according to the present example described below. The game system 10 is a system configured by a plurality of information processing apparatuses 1 communicating with each other. FIG. 4 is a diagram showing an example of the game system 10 and is a diagram showing an overview of the game system 10 configured by the plurality of information processing apparatuses 1 performing the local communication with each other. FIG. 5 is a diagram showing an example of the game system 10 and is a diagram showing an overview of the game system 10 configured by the plurality of information processing apparatuses 1 performing the Internet communication with each other.

As shown in FIGS. 4 and 5, the game system 10 includes a plurality of information processing apparatuses 1. For example, the game system 10 includes an information processing apparatus 1a, an information processing apparatus 1b, an information processing apparatus 1c, and an information processing apparatus 1d.

Although FIGS. 4 and 5 exemplify cases where the game system 10 includes four information processing apparatuses 1, the number of information processing apparatuses 1 included in the game system 10 may be optional. In both the communication forms shown in FIGS. 4 and 5, the plurality of information processing apparatuses 1 included in the game system 10 may operate in the mobile mode, or may operate in the stationary mode, or may operate in the table mode, or these modes may coexist. For example, in the communication form shown in FIG. 4, all the information processing apparatuses 1a to 1d may operate in the mobile mode, or may operate in the stationary mode, or may operate in the table mode, or the mobile mode, the stationary mode, and the table mode may coexist. Although in the game system 10 shown in FIG. 5, information processing apparatuses in the stationary mode (1a and 1b) and information processing apparatuses in the mobile mode (1c and 1d) coexist, an information processing apparatus in the table mode may be included, or all the information processing apparatuses 1a to 1d may operate in the mobile mode, or may operate in the stationary mode, or may operate in the table mode.

In FIGS. 4 and 5, the information processing apparatus 1a functions as a parent apparatus. The information processing apparatus 1a as the parent apparatus executes a game program. The processor 81 of the information processing apparatus 1a executes the game program, thereby executing game processing regarding a predetermined game. For example, an external storage medium that stores the game program can be attached to the slot 23 of the information processing apparatus 1a, and the processor 81 of the information processing apparatus 1a can read the game program stored in the external storage medium into the DRAM 85 and execute the game program. The game program may be stored in the flash memory 84 of the information processing apparatus 1a, or may be stored in another storage device that can be read by the information processing apparatus 1a. The predetermined game may be any game such as a racing game, a card game, a table game, a sport game, a fighting game, a shooting game, a role-playing game, a music game, or the like.

On the other hand, in FIGS. 4 and 5, the information processing apparatuses 1b to 1d function as child apparatuses. Each of the information processing apparatuses 1b to 1d as the child apparatuses may not store the game program for executing the predetermined game and not be able to execute the game program. That is, an external storage medium that stores the game program is not attached to the slot 23 of the child apparatus, and the game program is not stored in the flash memory 84 of the child apparatus, either.

Each child apparatus may also store the game program, but any one of the plurality of information processing apparatuses 1 may function as a parent apparatus, the remaining information processing apparatuses 1 may function as child apparatuses, and only the parent apparatus may execute game processing.

A plurality of child apparatuses may include an apparatus that only functions as a child apparatus.

A parent apparatus and child apparatuses may be information processing apparatuses of same type (e.g., game apparatuses of the same type). A parent apparatus and child apparatuses may be information processing apparatuses of different types. A plurality of child apparatuses may include an information processing apparatus of the same type as a parent apparatus and an information processing apparatus of a different type from the parent apparatus.

As shown in FIG. 4, a parent apparatus and child apparatuses may directly communicate with each other through local communication (e.g., a communication method based on a unique protocol or a method compliant with the Wi-Fi standard). As shown in FIG. 5, a parent apparatus and child apparatuses may communicate with each other via the Internet 8. In the present example, a predetermined game is executed using a parent apparatus and child apparatuses. The parent apparatus and the child apparatuses establish connections with each other before the predetermined game starts.

Specifically, a parent apparatus acquires operation data relating to an operation on the controller (the first controller or the second controller) of the parent apparatus or operation data detected by the touch panel 13, the acceleration sensor 89, or the angular velocity sensor 90 of the main body apparatus 2. Here, the operation data relating to an operation on the controller of the parent apparatus is referred to as “parent apparatus operation data”. A child apparatus transmits operation data relating to an operation on the controller (the first controller or the second controller) of the child apparatus to the parent apparatus or operation data detected by the touch panel 13, the acceleration sensor 89, or the angular velocity sensor 90 of the main body apparatus 2. Here, the operation data transmitted from the child apparatus to the parent apparatus is referred to as “child apparatus operation data”.

The parent apparatus performs game processing based on the parent apparatus operation data. The parent apparatus also receives the child apparatus operation data transmitted from the child apparatus and performs game processing based on the child apparatus operation data. The content of the game processing differs depending on the type of the game.

Next, the parent apparatus generates image data based on the result of the game processing. Specifically, the parent apparatus generates parent apparatus image data and child apparatus image data.

The parent apparatus outputs the generated parent apparatus image data to the display 12 or the stationary monitor 5. Consequently, a parent apparatus game image is displayed on the display 12 or the stationary monitor 5 of the parent apparatus. The parent apparatus also transmits the generated child apparatus image data to the child apparatus. The child apparatus receives the child apparatus image data transmitted from the parent apparatus and outputs the child apparatus image data to the display 12 or the stationary monitor 5. Consequently, a child apparatus game image is displayed on the display 12 or the stationary monitor 5 of the child apparatus. The parent apparatus may generate parent apparatus sound data and output a sound based on the sound data. The parent apparatus may also generate child apparatus sound data and transmit the child apparatus sound data to the child apparatus, and the child apparatus may output a sound based on the child apparatus sound data.

As described above, the game system 10 for performing the game according to the present example includes a plurality of information processing apparatuses 1, any one of the plurality of information processing apparatuses 1 functions as a parent apparatus, and the other information processing apparatuses 1 function as child apparatuses. Game processing is performed based on parent apparatus operation data relating to an operation performed on the parent apparatus. Child apparatus operation data relating to an operation performed on each child apparatus is transmitted from the child apparatus to the parent apparatus, and game processing based on the child apparatus operation data is performed by the parent apparatus. The parent apparatus generates a game image relating to the result of the game processing and displays the game image on the display 12 or the stationary monitor 5 of the parent apparatus. The parent apparatus also transmits a game image relating to the result of the game processing to the child apparatus, and the game image is displayed by the child apparatus. Consequently, a game is performed in the game system 10 including the parent apparatus and the child apparatuses.

Next, a description is given of examples of a system configuration in the game system 10 and a game that is performed using the game system 10.

### Explanation of First System Configuration and Example Game

A system configuration according to the present example includes a plurality of information processing apparatuses 1 and an attachment 8. At least one of the plurality of information processing apparatuses 1 is set as a parent apparatus while the other information processing apparatuses 1 are set as a child apparatus. The attachment 8 fixes at least one of the plurality of information processing apparatuses 1 in a predetermined arrangement.

As shown in FIG. 6, an attachment 8 that is used in a first system configuration fixes a plurality of main body apparatuses 2 adjacent to each other in a horizontal direction to each other. In the example shown in FIG. 6, a positional relationship between a main body apparatus 2a of an information processing apparatus 1a set as a parent apparatus and a main body apparatus 2b of an information processing apparatus 1b set as a child apparatus, is fixed by an attachment 8a with these main body apparatuses arranged adjacent to each other in a horizontal direction.

As shown in FIG. 1, the main body apparatus 2 of the information processing apparatus 1 has a housing having a horizontally elongated shape (landscape shape) that is wider in the left-right direction (a direction along the X axis in the figure) than it is high in the top-bottom direction (a direction along the Y axis in the figure). In the housing, a display 12 having a horizontally elongated shape is provided. In addition, the left controller 3 and the right controller 4 can be attached to a left surface and a right surface, respectively, of the main body apparatus 2. In the present example, the term “horizontal direction” means a direction along the X axis in the figure that is the longitudinal direction of the horizontally elongated shape of the housing or display 12 of the main body apparatus 2. The left controller 3 and the right controller 4 can be attached to the left and ride sides, respectively, in the horizontal direction of the main body apparatus 2.

The main body apparatuses 2 adjacent to each other in the horizontal direction are fixed to each other by the attachment 8a fixing the left surface of one of the main body apparatuses 2 and the right surface of the other to each other. For example, in the example of FIG. 6, the main body apparatus 2a of the parent apparatus and the main body apparatus 2b of the child apparatus are fixed to each other by the attachment 8a in a positional relationship in which the right surface (e.g., a side surface of the information processing apparatus 1a to which a right controller 4a can be attached) of the main body apparatus 2a is opposite the left surface (e.g., a side surface of the information processing apparatus 1b to which the left controller 3b can be attached) of the main body apparatus 2b with the right and left surfaces spaced from each other by a predetermined distance.

The left surface of the main body apparatus 2 is provided with an attachment/detachment mechanism that is capable of removably attaching the left controller 3 to the main body apparatus 2. For example, the left surface of the main body apparatus 2 is provided with a groove that allows the left controller 3 to be integrally fixed to the main body apparatus 2, as the attachment/detachment mechanism. As an example, the groove includes a rail member (rail groove) provided in the left surface of the main body apparatus 2. The rail member, which is for removably attaching the left controller 3 to the main body apparatus 2, is provided in the left surface, extending in the top-bottom direction (a direction along the Y axis shown in FIG. 1). The rail member is shaped to be able to engage with a slider provided on the right surface of the left controller 3. A slide mechanism constituted by the rail member and the slider serves as the attachment/detachment mechanism. As another example, the groove is a recess formed by hollowing a portion of the left surface. The groove is a recess that extends in the left surface of the main body apparatus 2 in the top-bottom direction, and has a magnetic member near the left surface. When a protrusion formed on the right surface of the left controller 3 is fitted into the groove, the left controller 3 is attracted and attached to the left surface of the main body apparatus 2 by the magnetic force of the magnetic member as an attractive force, so that the left controller 3 is attached to the main body apparatus 2. It should be noted that the right surface of the main body apparatus 2 is also provided with a groove that allows the right controller 4 to be removably attached to the main body apparatus 2, as with the groove in the left surface of the main body apparatus 2.

The attachment 8a is shaped to be able to be removably attached to the groove by engaging with or fitting into the groove, at the left and right surfaces of the attachment 8a. In the example of FIG. 6, the attachment 8a is removably fixed to the groove in the right surface of the main body apparatus 2a, to which the right controller 4a is not fixed, and the groove in the left surface of the main body apparatus 2b, to which the left controller 3b is not fixed. As a result, the two screens of the horizontally elongated-shaped displays 12 adjacent to each other in the horizontal direction can be used to play a game in operation embodiments below. In a first example, the main body apparatus 2a and the main body apparatus 2b are placed on a table or the like with these main body apparatuses fixed to each other by the attachment 8a such that the display screens are in an upright position, and a game is played by operating the left controller 3a and/or the right controller 4a wirelessly connected to the main body apparatus 2a. In a second example, in the first system configuration, the main body apparatus 2a and the main body apparatus 2b are placed on a table or the like with these apparatuses fixed to each other by the attachment 8a such that the display screens are laid in parallel with the placement surface, and a game is played by performing a touch operation on the touch panel 13a of the main body apparatus 2a, or operating the left controller 3a and/or the right controller 4a wirelessly connected to the main body apparatus 2a. In a third example, the main body apparatus 2a and the main body apparatus 2b are held by one hand with these apparatuses fixed to each other by the attachment 8a, and a game is played by performing a touch operation on the touch panel 13a of the main body apparatus 2a using the other hand. In a fourth example, the main body apparatus 2b is fixed, by the attachment 8a, to a controller-free side surface of the main body apparatus 2a with one of the left controller 3a and the right controller 4a attached to the main body apparatus 2a, and a game is played by operating the attached controller with the attached controller and the side portion of the main body apparatus 2b held by both hands.

In the first system configuration, the parent apparatus (the main body apparatus 2a) and the child apparatus (the main body apparatus 2b) directly communicate with each other through the local communication, and a game process is executed using the parent apparatus and the child apparatus. Specifically, the parent apparatus obtains parent apparatus operation data corresponding to an operation performed on a controller (a first controller or a second controller) of the parent apparatus. Based on the parent apparatus operation data, the parent apparatus executes a game process, and outputs game image data for the parent apparatus (hereinafter also referred to as “parent apparatus game image data”) generated by the game process to the display 12a of the parent apparatus, so that a game image for the parent apparatus (hereinafter also referred to as a “parent apparatus game image”) is displayed on the display 12a. The parent apparatus also transmits game image data for the child apparatus (hereinafter also referred to as “child apparatus game image data”) generated by the game process to the child apparatus. The child apparatus receives the child apparatus game image data, and outputs the child apparatus game image data to the display 12b of the child apparatus, so that a game image for the child apparatus (hereinafter also referred to as a “child apparatus game image”) is displayed on the display 12b.

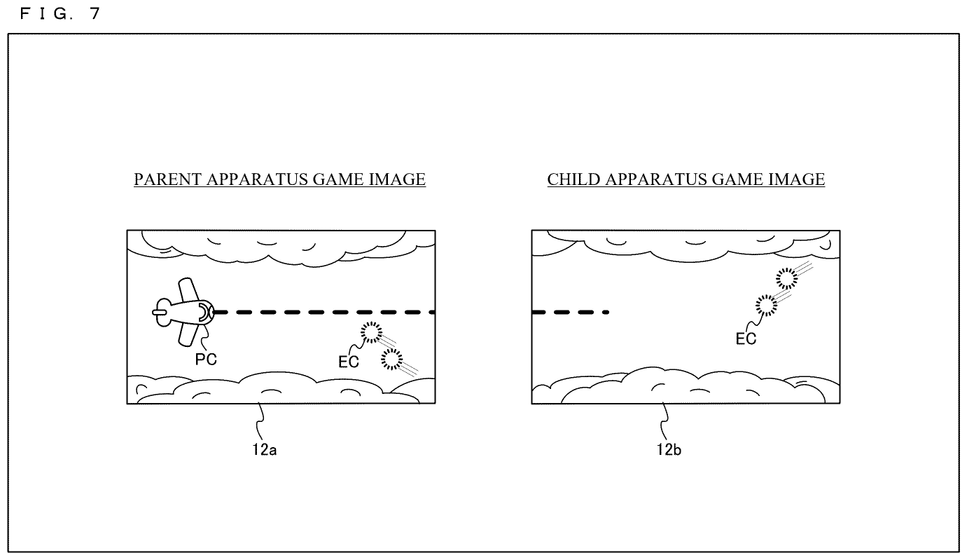

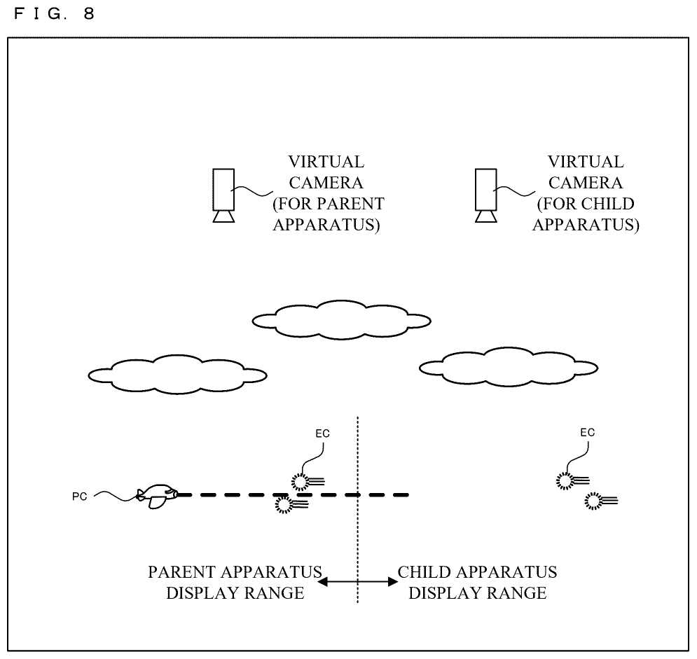

In a game process of the present example, a game image showing the same game space may be displayed on the display 12 of each of the parent apparatus and the child apparatus. For example, as shown in FIG. 7 and FIG. 8, in a game process in the first system configuration, a virtual camera for the parent apparatus and a virtual camera for the child apparatus are arranged in the game space at respective positions based on the arrangement of the main body apparatuses 2a and 2b. An image based on the virtual camera for the parent apparatus and an image based on the virtual camera for the child apparatus are displayed as a parent apparatus game image and a child apparatus game image, respectively. The positions of a plurality of main body apparatuses 2 that are used in the present example can be fixed in a predetermined physical positional relationship by the attachment 8. Therefore, the virtual cameras for the parent apparatus and the child apparatus can be arranged in the game space in respective predetermined positional relationships.

For example, in the example of FIG. 7 and FIG. 8, a player character PC whose action is controlled based on the parent apparatus operation data, and a plurality of enemy characters EC, are arranged in a game space. In addition, in the game space, a parent apparatus game image in a display range including the player character PC is generated based on the virtual camera for the parent apparatus. In the same game space, a child apparatus game image in a display range located away from the display range of the parent apparatus in a travel direction of the player character PC is generated based on the virtual camera for the child apparatus. By thus generating two game images, the two adjacent screens can be used to display a game image having a wider range of view of the game space and including a region toward which the player character PC is traveling. It should be noted that the position of the display range of the child apparatus that is away from the display range of the parent apparatus in the travel direction of the player character PC is set by arranging the virtual camera for the parent apparatus and the virtual camera for the child apparatus in the game space based on the positions in the real world of the main body apparatuses 2a and 2b. The display range of the parent apparatus and the display range of the child apparatus may overlap in the game space or may not overlap in the game space (e.g., the display ranges are in contact with each other or separated from each other).

It should be noted that in the present example, a game process that is a predetermined period of time later than that for the display range of a parent apparatus game image generated based on the virtual camera for the parent apparatus may be executed for the display range of a child apparatus game image generated based on the virtual camera for the child apparatus. For example, a game image that is to be displayed on the child apparatus is subjected to a process of transmitting and receiving image data from the parent apparatus to the child apparatus before being displayed on the display 12b, and therefore, a delay may occur due to the data communication including transmission and reception. In that case, the range in which the player character PC is allowed to move is limited to the display range of the parent apparatus game image. A time of RTT that it takes to communicate data between the parent apparatus and the child apparatus (a round trip time from when a request from the parent apparatus to the child apparatus is started to when the parent apparatus receives a response from the child apparatus) is measured, and a state of the game space that is a time of RTT/2 later (e.g., a future state of the game space RTT/2 later than the game space displayed in the parent apparatus game image) is displayed in the child apparatus game image, so that the user is not aware of a delay in communication. For example, in the case of a shooting game or the like performed by a player character PC, the pattern of appearance of enemy characters EC and the trajectory of a bullet fired by a player character PC can be easily uniquely determined, and therefore, a future state of a game space can be more easily predicted.

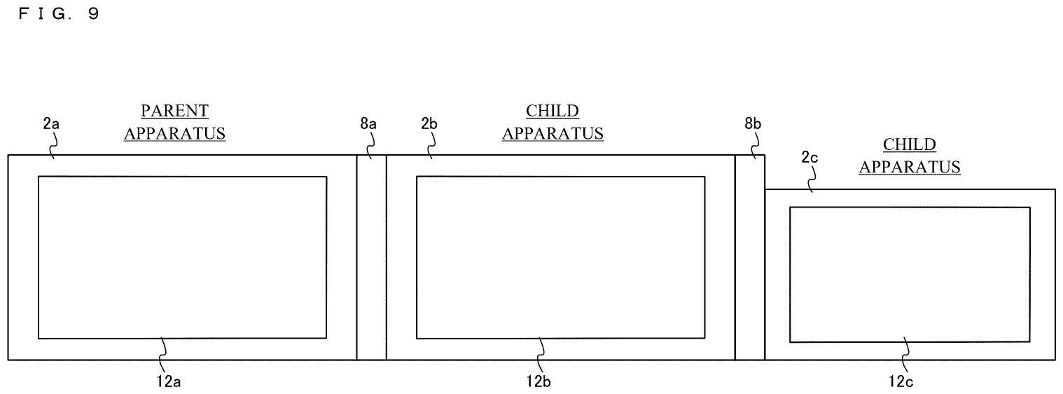

In addition, in the first system configuration, at least three apparatuses including main body apparatuses 2 and other types of apparatuses may be fixed to each other by attachments 8 with the apparatuses arranged adjacent to each other in the horizontal direction. For example, as shown in FIG. 9, main body apparatuses 2a and 2b are fixed to each other by an attachment 8a with the main body apparatuses 2a and 2b arranged adjacent to each other in the horizontal direction, and a main body apparatus 2c is fixed to the main body apparatus 2b by an attachment 8b with the main body apparatus 2c arranged adjacent to and to the right of the main body apparatus 2b. Here, the main body apparatus 2a serves as a parent apparatus, and the main body apparatuses 2b and 2c serve as a child apparatus. The main body apparatuses 2a and 2b are of the same type, and the type of the main body apparatus 2c is different from the type of the main body apparatuses 2a and 2b.

The attachment 8a is a type of attachment that fixes adjacent main body apparatuses 2 of the same type to each other (e.g., an attachment of type A that fixes apparatuses of type A adjacent to each other in the horizontal direction to each other). In contrast to this, the attachment 8b is a type of attachment that fixes adjacent main body apparatuses 2 of different types to each other (e.g., an attachment of type B that fixes an apparatus of type A and an apparatus of type B that are adjacent to each other in the horizontal direction to each other), and has a shape different from that of the attachment 8a. For example, different types of main body apparatuses 2 may have different housing sizes or shapes, or different groove structures in the left and right surfaces, and the attachment 8b may be adapted to the shape of an apparatus to be fixed. As an example, in a case where the groove of an apparatus of type A is configured by a rail member, and the groove of an apparatus of type B is configured by a recessed groove having an attractive force (e.g., a magnetic force), one side surface of the attachment 8b is configured to be able to engage with the rail member, and the other side surface is configured by a member that is shaped to fit into the recessed groove and receives the attractive force (e.g., a magnetic force).

It should be noted that when the attachment 8b fixes apparatus having different housing sizes or shapes to each other, as shown in FIG. 9 the attachment 8b may be shaped to support the apparatuses with the bottom surfaces of the apparatuses arranged flush with each other. When a plurality of apparatuses are thus fixed to each other with the bottom surfaces thereof arranged flush with each other, a plurality of main body apparatuses 2 fixed to each other by the attachment 8b can be placed on a table or the like with the display screens thereof arranged in an upright position, and in this state, a game can be played. It should be noted that if such an operation embodiment is not assumed, the attachment 8b may be shaped to support apparatuses having different housing sizes or shapes with the apparatuses sharing a horizontal central line, or with the top surfaces of the apparatuses arranged flush with each other.

Even when at least three main body apparatuses 2 are fixed to each other with the apparatuses arranged adjacent to each other in the horizontal direction, the parent apparatus and the plurality of child apparatuses directly communicate with each other through the local communication, and a game process is executed using the parent apparatus and the plurality of child apparatuses. Specifically, the parent apparatus executes a game process to generate game image data for each child apparatus, and transmit the game image data to the respective child apparatus. The plurality of child apparatuses receive and output the respective pieces of game image data to the respective displays (e.g., the displays 12b and 12c), so that respective game images are displayed on the respective displays (e.g., the displays 12b and 12c).

Even in a game process executed when at least three main body apparatuses 2 are fixed to each other with the apparatuses arranged adjacent to each other in the horizontal direction, a game image showing the same game space may be displayed on the display 12 of each of the parent apparatus and the plurality of child apparatuses. For example, in a game space, a virtual camera for a parent apparatus and virtual cameras for a plurality of child apparatuses are arranged based on the arrangement of main body apparatuses 2a, 2b, and 2c. An image based on the virtual camera for the parent apparatus is displayed as a parent apparatus game image, and an image based on the virtual camera for each child apparatus is displayed as a child apparatus game image. Even when at least three main body apparatuses 2 are fixed to each other, the plurality of main body apparatuses 2 can be fixed to each other by attachments 8 such that the positions of the main body apparatuses 2 can be fixed in a predetermined physical positional relationship, and therefore, a virtual camera for the parent apparatus and virtual cameras for the plurality of child apparatuses can be arranged in a positional relationship in a game space.

Specifically, in the game space, a parent apparatus game image in a display range including the player character PC is generated based on the virtual camera for the parent apparatus, and a child apparatus game image in a display range that is away from the display range of the parent apparatus in the travel direction of the player character PC, and a child apparatus game image in a display range that is further away, are generated based on the virtual cameras for the respective child apparatuses. By thus configuring at least three game images, a game image having a wider range of view of a game space toward which the player character PC is traveling can be displayed using at least three adjacent screens. It should be noted that the positions of the display ranges of the plurality of child apparatus that are away from the display range of the parent apparatus in the travel direction of the player character PC, are set by arranging the virtual camera for the parent apparatus and the virtual cameras for the plurality of child apparatus in the game space based on the positions in the real world of the main body apparatuses 2a, 2b, and 3b. The display range of the parent apparatus and the display ranges of the plurality of child apparatuses may overlap in the game space or may not overlap in the game space (e.g., the display ranges are in contact with each other or separated from each other).

It should be noted that when at least three main body apparatuses 2 are fixed to each other, a game process that is a predetermined period of time later than that for the display range of a parent apparatus game image generated based on a virtual camera for the parent apparatus may also be executed for the display range of a game image for each child apparatus generated based on a virtual camera for that child apparatus. For example, a time of RTT that it takes to communicate data between the parent apparatus and each child apparatus is measured, and a state of the game space as it is a time of RTT/2 later is displayed, depending on a time of RTT for each child apparatus.

The attachments 8a and 8b may be shaped to fix adjacent main body apparatuses 2 to each other by sandwiching an end portion of each main body apparatus 2 without engaging with or fitting into the groove. As used herein, the term “sandwich” means that an attachment is fixed to an end portion of a main body apparatus 2 (in the first system configuration, a left or right end portion thereof) by holding and supporting the end portion between two members of the attachment in the front-back direction. For example, the attachment 8a and 8b may have a structure that sandwiches a right end portion of one main body apparatus 2 in the front-back direction, and a structure that sandwiches a left end portion of another main body apparatus 2 in the front-back direction, and may be removably fixed to the main body apparatuses 2.

In addition, in the first system configuration, a game process is executed based on parent apparatus operation data based on an input to an operation device included in the parent apparatus (e.g., the touch panel 13, the acceleration sensor 89, or the angular velocity sensor 90), or an operation device connected to the parent apparatus (e.g., the left controller 3 or the right controller 4). In another example, a game process may also be executed based on child apparatus operation data based on an input to an operation device included in the child apparatus or an operation device connected to the child apparatus. For example, in a game space in which a player character of the parent apparatus performs an action based on parent apparatus operation data, a player character of the child apparatus that performs an action based on child apparatus operation data may be caused to appear. As an example, the game space is displayed on a plurality of adjacent displays 12, a range in which a player character of the parent apparatus is allowed to move is limited to the display range of a parent apparatus game image, and a range in which a player character of the child apparatus is allowed to move is limited to the display range of a child apparatus game image, whereby a game process can be executed based on respective pieces of operation data. In that case, a game process that is a predetermined period of time later than that for the display range of a parent apparatus game image may not be executed for the display range of a child apparatus game image.

### Explanation of Second System Configuration and Example Game

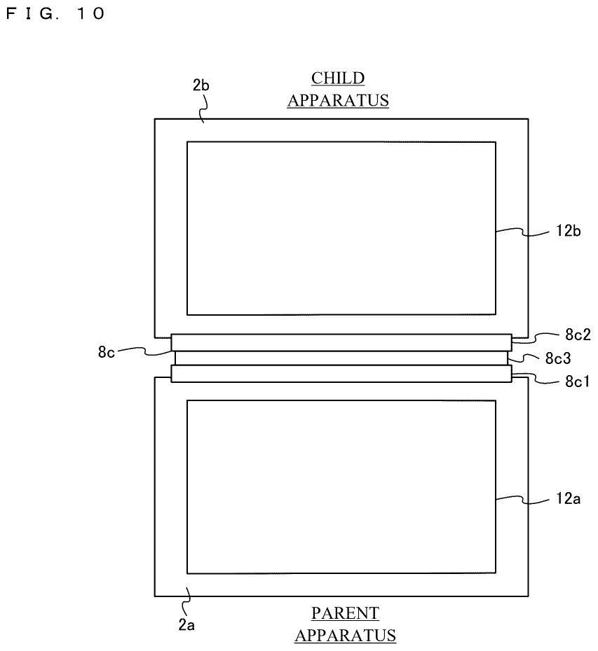

As shown in FIG. 10, an attachment 8 that is used in a second system configuration fixes a plurality of main body apparatuses 2 adjacent to each other in a vertical direction to each other. In an example shown in FIG. 10, a positional relationship between a main body apparatus 2a of an information processing apparatus 1a set as a parent apparatus, and a main body apparatus 2b of an information processing apparatus 1b set as a child apparatus, is fixed by an attachment 8c with these main body apparatuses arranged adjacent to each other in a vertical direction. In the present example, the term “vertical direction” means a direction along the Y axis in FIG. 1 that is the direction of the shorter side of the horizontally elongated shape of the housing or display 12 of a main body apparatus 2, and a direction in which main body apparatuses are fixed to each other using the top and bottom surfaces thereof, instead of the left and right surfaces thereof, to which the left controller 3 and the right controller 4 are attached.

The attachment 8c fixes main body apparatuses 2 adjacent to each other in the vertical direction by fixing a top portion of one of the apparatuses to a bottom portion of the other. For example, in the example of FIG. 10, the main body apparatus 2a as a parent apparatus and the main body apparatus 2b as a child apparatus are fixed to each other by the attachment 8c in a positional relationship in which a top portion of the main body apparatus 2a and a bottom portion of the main body apparatus 2b are opposite each other and are spaced from each other by a predetermined distance.

The attachment 8c has a first support member 8c1, a second support member 8c2, and a hinge member 8c3. The first support member 8c1 removably supports a top or bottom end portion of one of main body apparatuses 2 fixed to each other by the attachment 8c. The second support member 8c2 removably supports a top or bottom end portion of the other main body apparatus 2. The first support member 8c1 and the second support member 8c2 are each shaped to be able to be removably attached to the top or bottom end portion of a main body apparatus 2 by engaging with, fitting into, sandwiching, or the like the top or bottom end portion of the main body apparatus 2.

The hinge member 8c3 connects the first support member 8c1 and the second support member 8c2 together, and supports these support members in a manner that allows the connection portion to bend. The hinge member 8c3 is a hinge that supports two main body apparatuses 2 supported by the first support member 8c1 and the second support member 8c2 in a manner that allows these main body apparatuses 2 to be opened and closed. For example, the hinge member 8c3 can switch between an open state in which the displays 12 of two main body apparatuses 2 fixed to each other by the attachment 8c are arranged on the same plane (the state shown in FIG. 10) and a closed state in which the two displays 12 are arranged, facing each other.

Also in the second system configuration, the parent apparatus (the main body apparatus 2a) and the child apparatus (the main body apparatus 2b) directly communicate with each other through the local communication, and a game process is executed using the parent apparatus and the child apparatus. Specifically, the parent apparatus executes a game process based on the parent apparatus operation data, and outputs parent apparatus game image data generated by the game process to the display 12a of the parent apparatus, so that a parent apparatus game image is displayed on the display 12a. The parent apparatus also transmits, to the child apparatus, child apparatus game image data generated by the game process. The child apparatus receives and outputs the child apparatus game image data to the display 12b of the child apparatus, so that a child apparatus game image is displayed on the display 12b.

As a first example, also in a game process of the second system configuration, as in the first system configuration, a game image showing the same game space may be displayed on the display 12 of each of the parent apparatus and the child apparatus. For example, also in a game process of the second system configuration, as in the first system configuration, a virtual camera for the parent apparatus and a virtual camera for the child apparatus may be arranged in a game space at positions based on a physical positional relationship between the main body apparatuses 2a and 2b, an image based on the virtual camera for the parent apparatus and an image based on the virtual camera for the child apparatus may be displayed as a parent apparatus game image and a child apparatus game image, respectively. It should be noted that in the first example, a game process that is a predetermined period of time later than that for the display range of the parent apparatus game image generated based on the virtual camera for the parent apparatus may be executed for the display range of the child apparatus game image generated based on the virtual camera for the child apparatus. As a second example, in a game process of the second system configuration, an operation screen that receives the user's touch operation may be displayed on the display 12 of the parent apparatus, and a game image based on a touch operation using the operation screen may be displayed on the display 12 of the child apparatus.

Thus, in the second system configuration, a game can be played using the two screens of horizontally elongated-shaped displays 12 arranged adjacent to each other in the vertical direction in an operation embodiment below. In a first example, the main body apparatus 2a and the main body apparatus 2b are placed on a table or the like with these main body apparatuses fixed to each other by the attachment 8c, and a game is played by performing a touch operation on the touch panel 13a of the main body apparatus 2a. In a second example, the main body apparatus 2a and the main body apparatus 2b are held by one hand with these main body apparatuses fixed to each other by the attachment 8c, a game is played by performing a touch operation on the touch panel 13a of the main body apparatus 2a using the other hand. In a third example, the main body apparatus 2a and the main body apparatus 2b are placed on a table or the like with these main body apparatuses fixed to each other by the attachment 8c, and a game is played by operating a left controller 3a and/or a right controller 4a wirelessly connected to the main body apparatus 2a. In a fourth example, the main body apparatus 2b is fixed to the main body apparatus 2a by the attachment 8c with a left controller 3a and a right controller 4a attached to the main body apparatus 2a, and the left controller 3a and the right controller 4a are held by both hands, and a game is played by operating the left controller 3a and the right controller 4a.

It should be noted that also in the second system configuration, the attachment 8c may fix different types of apparatuses adjacent to each other in the vertical direction. In addition, at least two attachments 8c may fix at least three main body apparatuses 2 to each other. Even when different types of apparatuses or at least three apparatuses are arranged adjacent to each other and fixed to each other in the vertical direction, one of these apparatuses set as a parent apparatus and the others set as a child apparatus directly communicate with each other through the local communication, so that the game process is executed.

In addition, also in the second system configuration, as in the first system configuration, a game process may be executed based on the parent apparatus operation data, and in addition, child apparatus operation data based on an input to an operation device included in the child apparatus (e.g., the touch panel 13, the acceleration sensor 89, or the angular velocity sensor 90), or an operation device connected to the child apparatus (e.g., the left controller 3 or the right controller 4).

### Explanation of Third System Configuration and Example Game

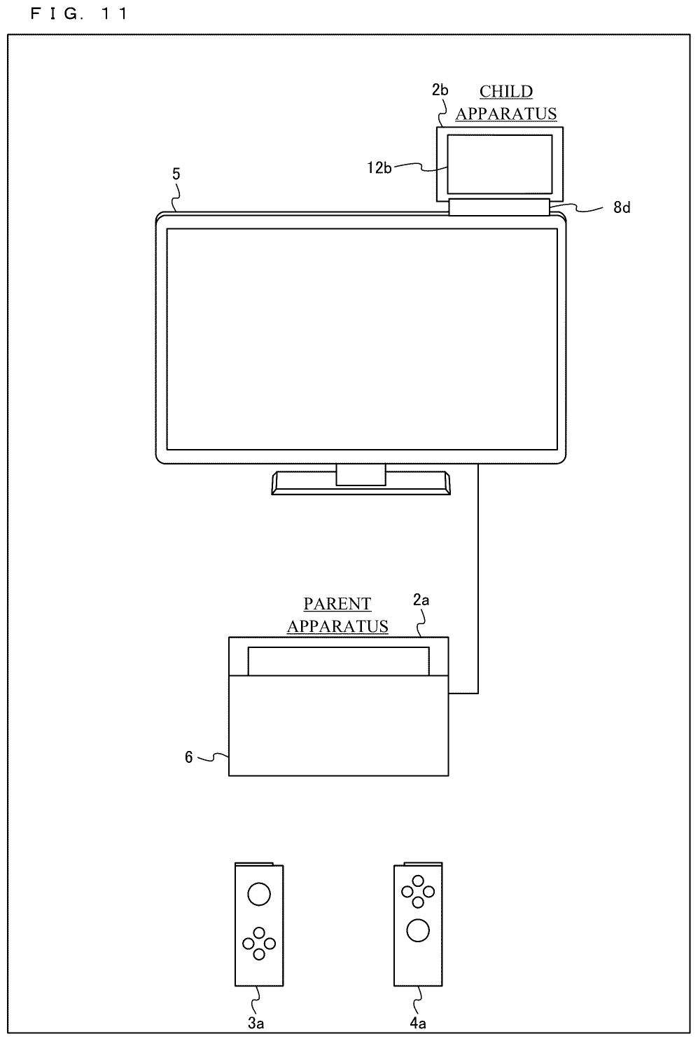

As shown in FIG. 11, an attachment 8 that is used in a third system configuration fixes a main body apparatus 2 to a stationary monitor 5 on which a parent apparatus operating in the stationary mode displays an image. In an example shown in FIG. 11, a main body apparatus 2b of an information processing apparatus 1b set as a child apparatus is fixed, by an attachment 8d, to a top portion of a stationary monitor 5 that is connected to a main body apparatus 2a of an information processing apparatus 1a set as a parent apparatus.

In the present example, the attachment 8d removably supports the main body apparatus 2b on the stationary monitor 5 in such a manner that a positional relationship between the stationary monitor 5 and the main body apparatus 2b is not changed, in a state in which the main body apparatus 2 is supported. In another example, the attachment 8d may support the stationary monitor 5 and the main body apparatus 2b using an arm mechanism having a plurality of joints, or the like, so as to allow the main body apparatus 2b to move upward, downward, leftward, rightward, forward, and backward relative to the stationary monitor 5, and rotate in roll, pitch, and yaw directions. It should be noted that in any of the examples, the attachment 8d may be able to be fixed to a top, bottom, left, and right end portions, a back surface, and the like of the main body apparatus 2 and the stationary monitor 5. The attachment 8d is shaped to be able to be removably attached to the stationary monitor 5 and the main body apparatus 2 by one end thereof engaging with, fitting into, sandwiching, or the like an end portion or back surface of the stationary monitor 5, and the other end engaging with, fitting into, sandwiching, or the like an end portion or back surface of the main body apparatus 2.

Also in the third system configuration, the parent apparatus (the main body apparatus 2a) and the child apparatus (the main body apparatus 2b) directly communicate with each other through the local communication, and a game process is executed using the parent apparatus and the child apparatus. Specifically, the parent apparatus, when operating in the stationary mode, executes a game process based on parent apparatus operation data based on the left controller 3a and/or the right controller 4a, which are removed from the main body apparatus 2a, to output parent apparatus game image data generated by the game process to the stationary monitor 5 connected to the parent apparatus through a cradle 6, so that a parent apparatus game image is displayed on the stationary monitor 5. The parent apparatus also transmits child apparatus game image data generated by the game process to the child apparatus. The child apparatus receives and outputs the child apparatus game image data to the display 12b of the child apparatus, so that a child apparatus game image is displayed on the display 12b.

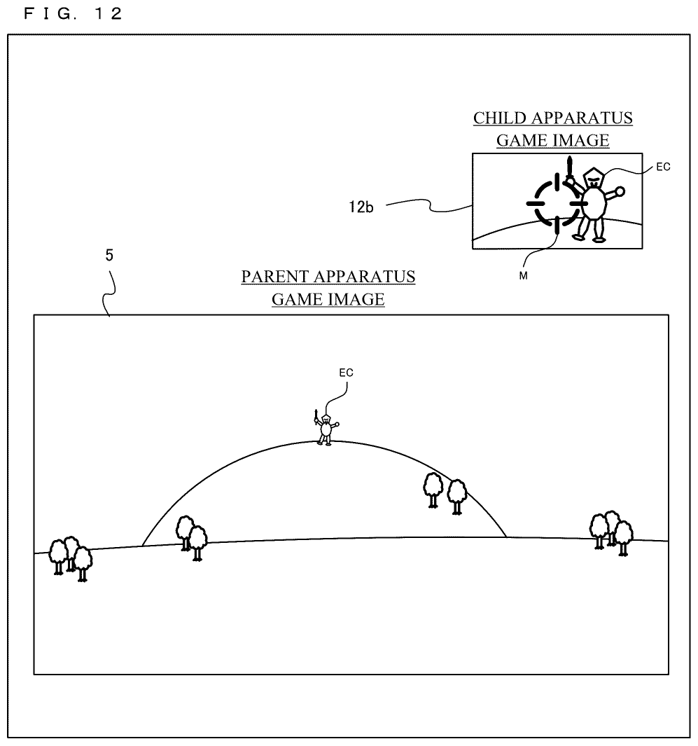

Also in a game process of the third system configuration, a game image showing the same game space may be displayed on the display 12 of each of the parent apparatus and the child apparatus. As a first example, as shown in FIG. 12, in the third system configuration, a parent apparatus game image is based on a virtual camera for the parent apparatus arranged in a game space. A child apparatus game image is based on a virtual camera for the child apparatus that captures an enlarged image of a predetermined position included in the range of view of the virtual camera for the parent apparatus.

For example, in the first example of FIG. 12, an enemy character EC is arranged in a game space. A parent apparatus game image (e.g., an image in a first-person point of view) obtained when a player character PC that performs an action based on parent apparatus operation data in the game space views the enemy character EC from far away, is generated based on the virtual camera for the parent apparatus. A child apparatus game image that shows an enlarged predetermined position included in the parent apparatus game image in the same game space, is generated based on the virtual camera for the child apparatus. For example, the virtual camera for the child apparatus generates an enlarged image as viewed through the telescopic sight of a weapon possessed by the player character PC. The telescopic sight can be moved in the game space in association with the movement of the player character PC, which performs an action based on parent apparatus operation data, and can change the direction of the optical axis and the magnification factor based on the parent apparatus operation data. The virtual camera for the child apparatus, which is moved in association with the movement and change of the player character PC, adds an aiming point M to a center of the range of view thereof to generate a child apparatus game image. The user can change the position indicated by the aiming point M, and fire a bullet object toward the position in the game space indicated by the aiming point M, by operating the left controller 3a and/or the right controller 4a, thereby attacking the enemy character EC.

In another example, a child apparatus game image may be based on a virtual camera for the child apparatus that captures a reduced image of a range wider than the range of view of a virtual camera for the parent apparatus. For example, a parent apparatus game image in a bird's-eye point of view in a game space is generated based on a virtual camera for the parent apparatus. A map image obtained by reducing a portion of the game space (e.g., a predetermined range around the position of a player character PC) is generated as a child apparatus game image based on the virtual camera for the child apparatus. In that case, a game can be played by viewing a main game image displayed on the stationary monitor 5 while referencing the map image displayed on the main body apparatus 2b of the child apparatus when necessary. When any of the game processes is executed, a game process that is a predetermined period of time later than that for the display range of a parent apparatus game image generated based on the virtual camera for the parent apparatus may also be executed for the display range of a child apparatus game image generated based on the virtual camera for the child apparatus.

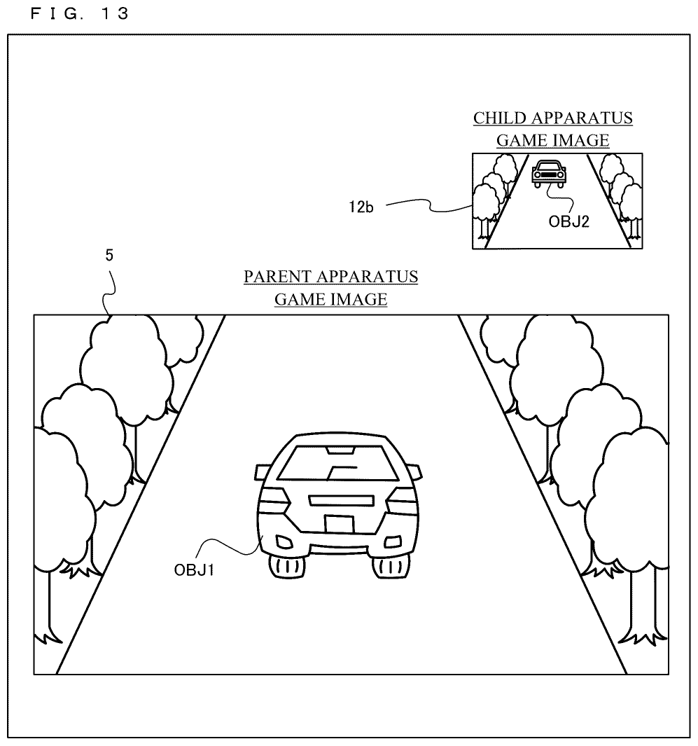

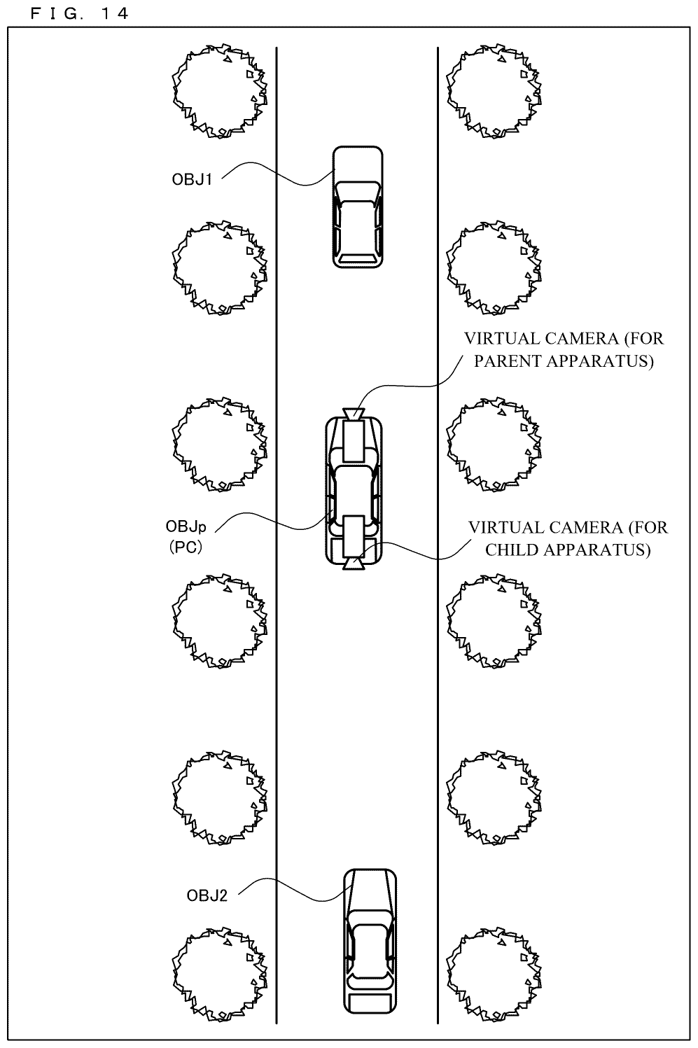

As a second example, as shown in FIG. 13 and FIG. 14, a parent apparatus game image in the third system configuration is based on a virtual camera for the parent apparatus arranged in a game space. A child apparatus game image is based on a virtual camera for the child apparatus that faces in a direction opposite to that of the virtual camera for the parent apparatus.

For example, in the second example of FIG. 13 and FIG. 14, an object OBJp in which a player character PC is sitting, and other objects (e.g., a first object OBJ1 and a second object OBJ2), are arranged in a game space. The object OBJp is a vehicle that travels in the game space based on parent apparatus operation data. The first object OBJ1 is traveling in front of the object OBJp in the same direction as the travel direction of the object OBJp. The second object OBJ2 is traveling behind the object OBJp in the same direction as the travel direction of the object OBJp. An image of a landscape of the game space as viewed in front of the object OBJp from the player character PC, sitting in the object OBJp, is generated as a parent apparatus game image based on a virtual camera for the parent apparatus that captures an image in the travel direction of the object OBJp in the game space. As a result, in the example of FIG. 13, the parent apparatus game image showing a landscape including the first object OBJ1, which is traveling in front of the object OBJp, is displayed on the stationary monitor 5. In addition, a child apparatus game image is generated based on a virtual camera for the child apparatus that captures an image in a direction opposite to that of the virtual camera for the parent apparatus in the same game space. For example, the virtual camera for the child apparatus generates an image of a landscape captured from the inside of the object OBJp (e.g., a rear-view mirror in the object OBJp) in a direction opposite to the travel direction of the object OBJp as a child apparatus game image. As a result, an image of a landscape behind the object OBJp is displayed on the main body apparatus 2b. In the example of FIG. 13, an image of a landscape showing a range of view behind the object OBJp that is reflected by the rear-view mirror, and including the second object OBJ2, which is traveling behind the object OBJp, is displayed as a child apparatus game image on the main body apparatus 2b. In this case, a game can be played by viewing the front image displayed on the stationary monitor 5 while viewing the rear image displayed on the main body apparatus 2b of the child apparatus when necessary. It should be noted that even when the game process is executed, a game process that is a predetermined period of time later than that for the display range of a parent apparatus game image generated based on the virtual camera for the parent apparatus may also be executed for the display range of a child apparatus game image generated based on the virtual camera for the child apparatus.

In a game process of the third system configuration, a game process for the parent apparatus may be executed using child apparatus operation data transmitted from the child apparatus. For example, when the main body apparatus 2b fixed to the stationary monitor 5 by the attachment 8d is supported in such a manner that the main body apparatus 2b is allowed to rotate in roll, pitch, and yaw directions relative to the stationary monitor 5, a game process may be executed based on child apparatus operation data depending on the orientation of the main body apparatus 2b set by the rotation. For example, a processor of the child apparatus (the main body apparatus 2b) transmits operation data based on an operation performed on a controller (a first controller or a second controller) of the child apparatus, and in addition, operation data indicating a position of the touch panel 13b of the main body apparatus 2b where a touch input has been performed, and operation data indicating the result of detection by an acceleration sensor 89b and an angular velocity sensor 90b of the main body apparatus 2b, as child apparatus operation data, to the parent apparatus. The parent apparatus can calculate information related to the motion and/or orientation of the main body apparatus 2b based on the results of detection by the acceleration sensor 89b and the angular velocity sensor 90b of the main body apparatus 2b. Thus, when the main body apparatus 2b is rotated in roll, pitch, and yaw directions relative to the stationary monitor 5, so that the orientation of the main body apparatus 2b is changed, the parent apparatus can calculate information related to a change in the orientation.

By using the thus-calculated information related to a change in the orientation of the main body apparatus 2b, the parent apparatus may change the orientation of the virtual camera for the child apparatus and then generate a child apparatus game image. For example, by changing the orientation of the virtual camera for the child apparatus based on a change in the orientation of the main body apparatus 2b, an image displayed on a screen (the display 12b of the main body apparatus 2b) that displays a child apparatus game image can be changed to correspond to the orientation of the screen. Specifically, if the orientation of the virtual camera for the child apparatus is changed like a change in the orientation of the main body apparatus 2b, the orientation of the rear-view mirror reflecting an image showing a game space behind the object OBJp is changed, so that an image showing a different landscape reflected by the rear-view mirror can be displayed on the main body apparatus 2b. When such child apparatus operation data is used to execute a game process for the parent apparatus, a game process that is a predetermined period of time later than that for the display range of a parent apparatus game image generated based on the virtual camera for the parent apparatus may also be executed for the display range of a child apparatus game image generated based on the virtual camera for the child apparatus.

Although in the third system configuration, the child apparatus (the main body apparatus 2b) is fixed to the stationary monitor 5 by the attachment 8d, the child apparatus (the main body apparatus 2b) may be fixed, by the attachments 8a to 8d or other attachments, to other household goods, structures, tools, and the like (e.g., a television stand for placing the stationary monitor 5, and a table on which a parent apparatus (main body apparatus 2a) operating in the table mode is placed). In addition, although in the third system configuration, the attachment 8d is not fixed to the parent apparatus (the main body apparatus 2a) itself, the child apparatus may be fixed to the parent apparatus (the main body apparatus 2a) itself by the attachments 8a and 8d or other attachments when the parent apparatus is operated in the table mode or handheld mode.

In addition, the physical positional relationships between the parent apparatus and the child apparatus shown in the first to third system configurations may be reversed. Specifically, in the first to third system configurations, the main body apparatus 2b may be set as a parent apparatus, and the main body apparatus 2a (and 2c) may be set as a child apparatus. In that case, a game process may be executed based on operation data based on an input to an operation device included in the main body apparatus 2b as a parent apparatus (e.g., the touch panel 13b, the acceleration sensor 89b, or the angular velocity sensor 90b), or an operation device connected to the main body apparatus 2b as a parent apparatus (e.g., the left controller 3b or the right controller 4b). In addition, in that case, in the third system configuration, the parent apparatus (the main body apparatus 2b) may be fixed to the stationary monitor 5 or the like by the attachment 8d, and the attachment 8d may not be fixed to the child apparatus (the main body apparatus 2a) itself.

In addition, the image size (resolution) of the child apparatus image data in the first to third system configurations may be variable. For example, the image size of the child apparatus image data may be changed, depending on the number of child apparatuses connected to the parent apparatus. In addition, the image size of the parent apparatus image data may be different from the image size of the child apparatus image data.

In addition, in the first to third system configurations, the parent apparatus and the child apparatus may communicate with each other through the Internet 8.

### Details of Processes of Parent Apparatus and Child Apparatus

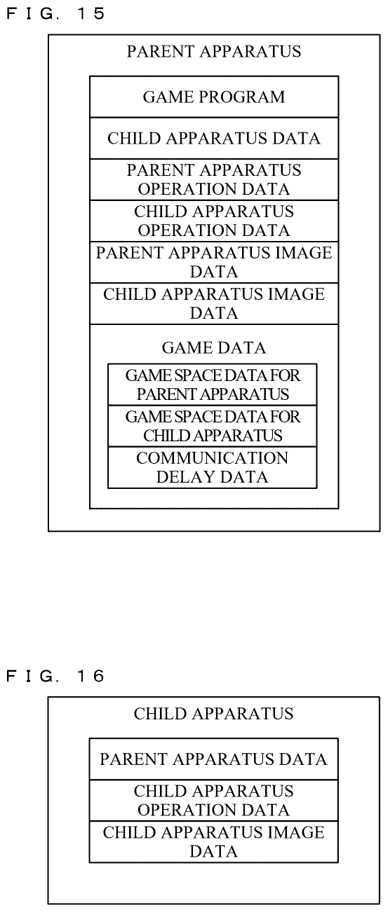

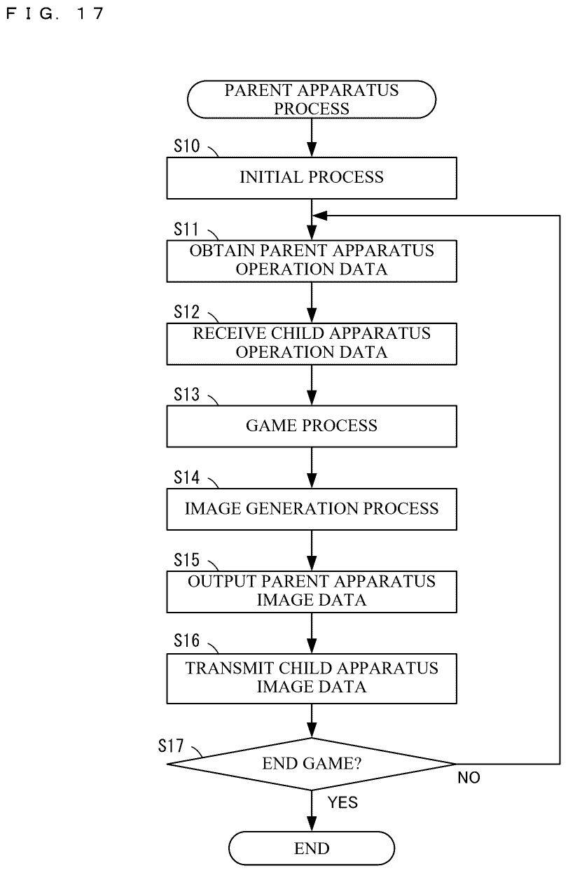

Next, the details of processes performed by a parent apparatus and a child apparatus are described. First, data stored in the parent apparatus and the child apparatus is described. FIG. 15 is a diagram showing an example of the data stored in the parent apparatus. FIG. 16 is a diagram showing an example of the data stored in the child apparatus. The data shown in FIGS. 15 and 16 is stored in a memory (any of an external storage medium, the flash memory 84, and the DRAM 85) of each main body apparatus 2.

As shown in FIG. 15, the parent apparatus stores a game program, child apparatus data, parent apparatus operation data, child apparatus operation data, parent apparatus image data, child apparatus image data, and game data.

The game program is a program for executing a predetermined game and is a program for executing game processing described below.

The child apparatus data is data regarding a child apparatus connected to the parent apparatus. For example, the child apparatus data includes information (e.g., an apparatus ID, a MAC address, or the like) that identifies the child apparatus. The child apparatus data is stored with respect to each child apparatus connected to the parent apparatus.

The parent apparatus operation data is data relating to an operation performed on the controller (the first controller or the second controller) of the parent apparatus and data relating to an operation performed on the main body apparatus 2 (the touch panel 13, the acceleration sensor 89, and the angular acceleration sensor 90). The main body apparatus 2 of the parent apparatus acquires the parent apparatus operation data from the controller, the touch panel 13, the acceleration sensor 89, and the angular acceleration sensor 90 of the parent apparatus at predetermined time intervals (e.g., 1/200-second intervals).

The child apparatus operation data is data relating to an operation performed on the controller (the first controller or the second controller) or the main body apparatus 2 (the touch panel 13, the acceleration sensor 89, and the angular acceleration sensor 90) of the child apparatus and is transmitted from the child apparatus. The child apparatus transmits the child apparatus operation data to the parent apparatus at predetermined time intervals (e.g., 1/60-second intervals). In a case where a plurality of child apparatuses are connected to the parent apparatus, the child apparatus operation data received from each of the child apparatuses is stored. It should be noted that in a system configuration that does not use the child apparatus operation data, the child apparatus operation data may not be stored in a memory of the parent apparatus.

The parent apparatus image data is image data indicating a game image displayed on the screen of the parent apparatus (the screen of the display 12 or the stationary monitor 5) and is generated by the parent apparatus.

The child apparatus image data is image data indicating a game image displayed on the screen of the child apparatus (the screen of the display 12 or the stationary monitor 5) and is data generated by the parent apparatus and transmitted to the child apparatus. In a case where a plurality of child apparatuses are connected to the parent apparatus, the child apparatus image data of each of the plurality of child apparatuses is generated and stored.

The game data includes game space data for the parent apparatus, game space data for the child apparatus, and communication delay data. The game space data for the parent apparatus indicates a state of a game space for arranging a virtual camera for the parent apparatus and generating a parent apparatus game image. The game space data for the child apparatus indicates a state of a game space for arranging a virtual camera for the child apparatus and generating a child apparatus game image. The display range of the child apparatus game image indicates the game space for the child apparatus as it is a predetermined period of time later than the game space for the parent apparatus. The communication delay data indicates a round trip time (RTT) that it takes from the start of a request from the parent apparatus to the child apparatus until the parent apparatus receives a response from the child apparatus.

Meanwhile, as shown in FIG. 16, the child apparatus stores parent apparatus data, child apparatus operation data, and child apparatus image data.

The parent apparatus data is data regarding a parent apparatus connected to the child apparatus. For example, the parent apparatus data includes information (e.g., an apparatus ID, a MAC address, or the like) that identifies the parent apparatus.

The child apparatus operation data corresponds to an operation performed on a controller (first or second controller) or the main body apparatus 2 (the touch panel 13, the acceleration sensor 89, and the angular velocity sensor 90) of the child apparatus. The main body apparatus 2 obtains the child apparatus operation data from the controller, the touch panel 13, the acceleration sensor 89, and the angular velocity sensor 90 of the child apparatus at predetermined time intervals (e.g., 1/200-second intervals). In addition, the child apparatus transmits, to the parent apparatus, the obtained child apparatus operation data at predetermined time intervals (e.g., 1/60-second intervals). It should be noted that in the case of a system configuration in which the child apparatus operation data is not used, the child apparatus operation data may not be stored in a memory for the child apparatus.

The child apparatus image data indicates a game image that is displayed on a screen for the child apparatus (the display 12 or the screen of the stationary monitor 5), and is received from the parent apparatus.

The child apparatus does not store the above game program, but stores a program for participating in the game performed by the parent apparatus (a program for connecting to the parent apparatus, a program for making a participation request to the parent apparatus, or the like).

Next, the processes performed by the parent apparatus and the child apparatus are described. The following description is given on the assumption that a parent apparatus and child apparatuses are connected together in the communication form shown in FIG. 4. A parent apparatus and child apparatuses may be connected together in the communication form shown in FIG. 5. In addition, steps described below, which are merely illustrative, may be executed in a different order, or another step may be executed in addition to (or instead of) each step, if a similar effect is obtained. In the present example, it is assumed that the processor 81 of the base or child apparatus executes each step of the flow charts. Alternatively, a portion of the steps of the flow charts may be executed by a processor or dedicated circuit other than the processor 81. In addition, a portion of the steps executed by the main body apparatus 2 may be executed by another information processing apparatus that can communicate with the main body apparatus 2 (e.g., a server that can communicate with the main body apparatus 2 through a network). Specifically, steps described below may be executed by a plurality of information processing apparatuses including the main body apparatus 2 cooperating with each other.

### Parent Apparatus Process

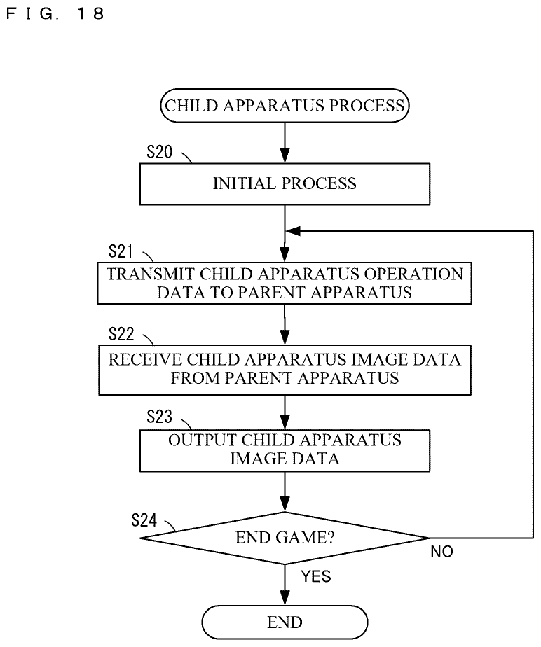

FIG. 17 is a flow chart showing an example of a parent apparatus process performed by the parent apparatus when a predetermined game is performed in the game system 10. A series of processes shown in FIG. 17 is executed by the processor 81 of the main body apparatus 2 of the parent apparatus executing a predetermined application program (game program). The parent apparatus process of FIG. 17 is started with any appropriate timing.

As shown in FIG. 17, first, the parent apparatus performs an initial process (step S10). In the initial process, based on an operation of a user, the process of determining a game to be executed, the process of selecting a communication form (the local communication or the Internet communication), the process of setting an information processing apparatus 1 as the parent apparatus, the process of connecting the parent apparatus and a child apparatus, a process for inviting a user (a child apparatus) to participate in the game, a process for causing a child apparatus that makes a participation request to participate in the game, a process for measuring a communication delay time (round trip time (RTT)) between the parent apparatus and a child apparatus permitted to participate, and the like are performed. A communication form configured to be selected by the user differs in accordance with the game to be executed. If the initial process ends, the parent apparatus starts the game, and from this point onward, repeatedly executes the processes of steps S11 to S17 at predetermined time intervals (e.g., 1/60-second intervals).

After the process of step S10, the parent apparatus acquires parent apparatus operation data (step S11). Specifically, if the parent apparatus operates in the mobile mode, the parent apparatus acquires parent apparatus operation data from the main body apparatus 2 or the first controller (the left controller 3 and the right controller 4) attached to the parent apparatus. If the parent apparatus operates in the stationary mode or the table mode, the parent apparatus acquires parent apparatus operation data from the main body apparatus 2 or the first controller or the second controller wirelessly connected to the parent apparatus.

Next, the parent apparatus receives child apparatus operation data from child apparatuses (step S12). Specifically, the network communication section 82 of the parent apparatus receives child apparatus operation data transmitted from each child apparatus. The timings when the parent apparatus receive the child apparatus operation data from the child apparatuses may be different from each other. In addition, in the case of a system configuration in which the child apparatus operation data is not used, the parent apparatus may skip the process of step S12.

Next, the parent apparatus executes a game process based on the parent apparatus operation data (step S13). In addition, in step S13, in the case of a system configuration in which the child apparatus operation data is used, the parent apparatus executes a game process based on the received child apparatus operation data.

For example, in step S13, the parent apparatus sets game space data for the parent apparatus based on the received parent apparatus operation data. As an example, the parent apparatus sets game space data for the parent apparatus by setting the action, position, direction, pose, state, and the like of a player character operated by the user of the parent apparatus based on the parent apparatus operation data, and causing the player character to perform an action based on virtual physical calculation or the like in the game space. In addition, the parent apparatus sets game space data for the parent apparatus by setting the action, position, direction, pose, state, and the like of an enemy character or another object, and causing the enemy character or object to perform an action, based on the player character PC's action, virtual physical calculation in the game space, or the like.

In addition, in step S13, the parent apparatus sets game space data for the child apparatus based on the set game space data for the parent apparatus. As an example, concerning the display range of a child apparatus game image, the parent apparatus predicts a state of the game space as it is a time of RTT/2 later than the set game space for the parent apparatus, and sets the game space data for the child apparatus based on the result of the prediction.

Next, the parent apparatus performs an image generation process based on the result of the game processing (step S14). Specifically, in the image generation process, the parent apparatus generates parent apparatus image data and child apparatus image data. The parent apparatus may also generate parent apparatus sound data and child apparatus sound data.

For example, in step S14, the parent apparatus arranges a virtual camera for the parent apparatus in the game space for the parent apparatus, and generates image data of the game space as viewed from the virtual camera for the parent apparatus as the parent apparatus game image data. It should be noted that the position and orientation of the virtual camera for the parent apparatus in the game space may be set based on the position, direction, pose, and the like of a player character operated by the user of the parent apparatus.

In addition, in step S14, the parent apparatus arranges a virtual camera for the child apparatus in a game space for the child apparatus, and generates image data of the game space as viewed from the virtual camera for the child apparatus as the child apparatus game image data. In the case of the first and second system configurations, the position and orientation of the virtual camera for the child apparatus may be set with reference to the position of the virtual camera for the parent apparatus, based on a positional relationship in the real world between the display 12 of the parent apparatus and the display 12 of the child apparatus. In the case of the first example (the example of FIG. 12) of the third system configuration, the position and orientation of the virtual camera for the child apparatus may be set based on the position, direction, pose, and the like of a player character (e.g., the position and direction of a telescopic sight held by the player character). In the case of the second example (the example of FIG. 13 and FIG. 14) of the third system configuration, the position and line-of-sight direction of the virtual camera for the child apparatus may be set to a position with reference to the position of the virtual camera for the parent apparatus and a direction opposite to the line-of-sight direction of the virtual camera for the parent apparatus. In that case, the orientation of the virtual camera for the child apparatus may be set based on a change in the orientation of the main body apparatus 2 of the child apparatus calculated from the child apparatus operation data received in step S13.

Next, the parent apparatus outputs the parent apparatus image data generated in step S14 to the display 12 or the stationary monitor 5 (step S15). In addition, the parent apparatus causes a loudspeaker 88 or a loudspeaker of the stationary monitor 5 to output sounds based on the audio data for the parent apparatus generated in step S14.

Next, the parent apparatus transmits the child apparatus image data generated in step S14 to the child apparatuses (step S16). Specifically, the network communication section 82 of the parent apparatus transmits the generated child apparatus image data to the child apparatuses. The network communication section 82 of the parent apparatus also transmits the generated sound data to the child apparatuses when necessary.

Next, the parent apparatus determines whether or not to end the game (step S17). For example, if the game is completed, or if the user of the parent apparatus gives an instruction to force termination of the game during the game, or if child apparatus operation data regarding forced termination of the game is received from any of the child apparatuses during the game, the determination of the parent apparatus is YES in step S17. If the determination is YES in step S17, the parent apparatus ends the game and transmits a game end notification to the child apparatuses. If the determination is NO in step S17, the parent apparatus executes the process of step S11 again. The description of the parent apparatus process ends.

While the processes of steps S11 to S17 are repeatedly executed, i.e., while a predetermined game is performed between the parent apparatus and the child apparatuses, a new child apparatus may participate.

### Child Apparatus Process

FIG. 18 is a flow chart showing an example of a child apparatus process performed by the child apparatus.

As shown in FIG. 18, first, the child apparatus performs an initial process (step S20). In the initial process, based on an operation of a user, the process of setting an information processing apparatus 1 as the child apparatus, the process of selecting a parent apparatus to which to connect, a process for transmitting a participation request to participate in a game performed by the parent apparatus, a process of transmitting a response to a request for measuring a communication delay time transmitted from a parent apparatus for which the child apparatus has been permitted to participate in the game, and the like are performed. If the game is started by the parent apparatus, the child apparatus ends the initial process. From this point onward, the child apparatus repeatedly executes the processes of steps S21 to S24 at predetermined time intervals (e.g., 1/60-second intervals).

If the game is started, the child apparatus transmits child apparatus operation data to the parent apparatus (step S21). Specifically, if the child apparatus operates in the mobile mode, the child apparatus acquires operation data output from the main body apparatus 2 or the first controller (the left controller 3 and the right controller 4) attached to the child apparatus. If the child apparatus operates in the stationary mode or the table mode, the child apparatus acquires operation data output from the main body apparatus 2 or the first controller or the second controller connected to the child apparatus. Then, the network communication section 82 of the child apparatus transmits the acquired operation data as child apparatus operation data to the parent apparatus. Operation data output from the controller of the child apparatus may be transmitted as child apparatus operation data to the parent apparatus, or data obtained by performing a predetermined process on operation data output from the controller of the child apparatus may be transmitted as child apparatus operation data to the parent apparatus. In addition, the child apparatus may also transmit, in any mode, data obtained from the touch panel 13, the acceleration sensor 89, and the angular velocity sensor 90 thereof, or data obtained by executing a predetermined process on that data, as the child apparatus operation data, to the parent apparatus. In addition, in the case of a system configuration in which the child apparatus operation data is not used, the child apparatus may skip the process of step S21.

Next, the child apparatus receives child apparatus image data from the parent apparatus (step S22). The child apparatus may also receive child apparatus sound data from the parent apparatus when necessary.

The frequency of transmission of the child apparatus operation data from the child apparatus and the frequency of reception (the frame rate) of the child apparatus image data by the child apparatus may be different from each other. For example, the frequency of reception of the child apparatus image data may be lower than the frequency of transmission of the child apparatus operation data. For example, in accordance with the number of child apparatuses connected to the parent apparatus, the frequencies of reception of the child apparatus image data by the child apparatuses may be lowered. In this case, the frequencies of transmission of the child apparatus operation data from the child apparatuses may be the same as each other, regardless of the number of child apparatuses connected to the parent apparatus.

Next, the child apparatus outputs the received child apparatus image data (step S23). Specifically, if the child apparatus operates in the mobile mode or the table mode, the child apparatus outputs the received child apparatus image data to the display 12. If the child apparatus operates in the stationary mode, the child apparatus outputs the received child apparatus image data to the stationary monitor 5. The child apparatus may also output a sound based on the received sound data.

Next, the child apparatus determines whether or not to end the game (step S24). For example, if the child apparatus receives a game end notification from the parent apparatus, or if an instruction to force termination of the game is given in the child apparatus during the game, the child apparatus ends the game. If the game is not to be ended, the child apparatus executes the process of step S21 again. The description of the child apparatus process ends.

Thus, in the present example, in a game system that has a function of distributing an image from a parent apparatus to child apparatuses, information processing apparatuses are fixed together in a predetermined arrangement by an attachment, whereby a game can be executed by novel and various methods.

It should be noted that the information processing apparatus 1 may be any suitable apparatus, including handheld game apparatuses, personal digital assistants (PDAs), mobile telephones, smartphones, personal computers, cameras, tablet computers, and the like.

In the foregoing, the information process (game process) is performed in the information processing apparatus 1 by way of example. Alternatively, at least a portion of the process steps may be performed in another apparatus. For example, when the information processing apparatus 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the information processing apparatus 1 executing predetermined programs. Alternatively, all or a portion of the above processes may be performed by a dedicated circuit included in the information processing apparatus 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the information processing apparatus 1 not only through an external storage medium, such as an external memory, but also through a wired or wireless communication line. The program may be previously stored in a non-volatile storage device in the information processing apparatus 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is applicable as a game system, game processing method, and the like that are capable of executing a game and the like by novel and various methods.

What is claimed is:

1. A game system comprising:
a plurality of information processing apparatuses including one or more processors; and
an attachment configured to fix at least one of the plurality of information processing apparatuses in an arrangement, wherein
at least one of the plurality of information processing apparatuses serves as a parent apparatus, and the other information processing apparatuses serve as a child apparatus,
the one or more processors of the parent apparatus are configured to execute information processing including
communicating with at least one of the child apparatuses,
obtaining first operation data based on an input to an operation device included in or connected to the parent apparatus,
executing a game process based on at least the first operation data,
generating a first image and at least one second image based on the game process,
outputting the first image to a display device included in or connected to the parent apparatus, and
transmitting the at least one second image to the at least one child apparatus, respectively, and
the one or more processors of each child apparatus are configured to execute information processing including
communicating with the parent apparatus, and
outputting the second image received from the parent apparatus to a display device included in or connected to the child apparatus.

2. The game system according to claim 1, wherein
the arrangement is such that the display devices included in the plurality of information processing apparatuses are arranged in a horizontal direction, and
the attachment is configured to fix adjacent ones in the horizontal direction of the plurality of information processing apparatuses to each other.

3. The game system according to claim 2, wherein
each information processing apparatus includes a groove configured to integrally fix the operation device thereto, and
the attachment is configured to be fixed to the grooves of two adjacent ones of the plurality of information processing apparatuses instead of the operation device being fixed to the two grooves.

4. The game system according to claim 1, wherein
the one or more processors of the parent apparatus are configured to execute information processing including
generating, as the first image and the second images, images based on virtual cameras arranged at positions based on an arrangement of the plurality of information processing apparatuses in a virtual space, and
executing the game process on a range included in each second image in the virtual space, the range being a respective period of time later than a range included in the first image.

5. The game system according to claim 1, wherein
the arrangement is such that the display devices included in the plurality of information processing apparatuses are arranged in a vertical direction, and
the attachment is configured to fix adjacent ones in the vertical direction of the plurality of information processing apparatuses to each other.

6. The game system according to claim 5, wherein
the arrangement is such that the display devices included in two of the information processing apparatuses are arranged in the vertical direction, and
the attachment includes
a first and a second support member each configured to support the respective one of the two information processing apparatuses, and
a hinge member configured to connect the first and second support members together and bend at the connection portion.

7. The game system according to claim 1, wherein
the arrangement is such that the display device included in the child apparatus is fixed to the display device connected to the parent apparatus, and
the attachment is configured to fix the display device included in the child apparatus to the display device connected to the parent apparatus.

8. The game system according to claim 7, wherein
the first image is based on a first virtual camera in a virtual space, and
the second image is based on a second virtual camera configured to capture an enlarged image of a position included in a range of view of the first virtual camera.

9. The game system according to claim 7, wherein
the first image is based on a first virtual camera in a virtual space, and
the second image is based on a second virtual camera facing in a direction opposite to a direction in which the first virtual camera faces.

10. The game system according to claim 1, wherein
the one or more processors of the child apparatus are further configured to transmit, to the parent apparatus, second operation data based on an input to an operation device included in or connected to the child apparatus, and
the one or more processors of the parent apparatus are further configured to execute a game process based on the second operation data.

11. A game processing method performed on an information processing system, wherein
the information processing system includes
a plurality of information processing apparatuses, and
an attachment configured to fix at least one of the plurality of information processing apparatuses in an arrangement,
at least one of the plurality of information processing apparatuses serves as a parent apparatus, and the other information processing apparatuses serve as a child apparatus,
the parent apparatus are configured to at least
communicate with at least one of the child apparatuses,
obtain first operation data based on an input to an operation device included in or connected to the parent apparatus,
execute a game process based on at least the first operation data,
generate a first image and at least one second image based on the game process,
output the first image to a display device included in or connected to the parent apparatus, and
transmit the at least one second image to the at least one child apparatus, respectively, and
each child apparatus is configured to at least
communicate with the parent apparatus, and
output the second image received from the parent apparatus to a display device included in or connected to the child apparatus.

12. The game processing method according to claim 11, wherein
the arrangement is such that the display devices included in the plurality of information processing apparatuses are arranged in a horizontal direction, and
the attachment is configured to fix adjacent ones in the horizontal direction of the plurality of information processing apparatuses to each other.

13. The game processing method according to claim 12, wherein
each information processing apparatus includes a groove configured to integrally fix the operation device thereto, and
the attachment is configured to be fixed to the grooves of two adjacent ones of the plurality of information processing apparatuses instead of the operation device being fixed to the two grooves.

14. The game processing method according to claim 11, wherein
the parent apparatus is configured to at least
generate, as the first image and the second images, images based on virtual cameras arranged at positions based on an arrangement of the plurality of information processing apparatuses in a virtual space, and
execute the game process on a range included in each second image in the virtual space, the range being a respective period of time later than a range included in the first image.

15. The game processing method according to claim 11, wherein
the arrangement is such that the display devices included in the plurality of information processing apparatuses are arranged in a vertical direction, and
the attachment is configured to fix adjacent ones in the vertical direction of the plurality of information processing apparatuses to each other.

16. The game processing method according to claim 15, wherein
the arrangement is such that the display devices included in two of the information processing apparatuses are arranged in the vertical direction, and
the two information processing apparatuses are fixed to each other by the attachment including a first and a second support member each configured to support the respective one of the two information processing apparatuses, and a hinge member configured to connect the first and second support members together and bend at the connection portion.

17. The game processing method according to claim 11, wherein
the arrangement is such that the display device included in the child apparatus is fixed to the display device connected to the parent apparatus, and
the attachment is configured to fix the display device included in the child apparatus to the display device connected to the parent apparatus.

18. The game processing method according to claim 17, wherein
the first image is based on a first virtual camera in a virtual space, and
the second image is based on a second virtual camera configured to capture an enlarged image of a position included in a range of view of the first virtual camera.

19. The game processing method according to claim 17, wherein
the first image is based on a first virtual camera in a virtual space, and
the second image is based on a second virtual camera facing in a direction opposite to a direction in which the first virtual camera faces.

20. The game processing method according to claim 11, wherein
the child apparatus is further configured to transmit, to the parent apparatus, second operation data based on an input to an operation device included in or connected to the child apparatus, and
the parent apparatus is further configured to execute a game process based on the second operation data.
